(19) United States
(12) Patent Application Publication
(10) Pub. No.: US 2026/0079453 A1
(43) Pub. Date: Mar. 19, 2026

(54) SYSTEM AND METHOD FOR SMART MANUFACTURING QUALITY CONTROL WITH FEW-SHOT VISUAL REASONING

(71) Applicants: Sangeeta SINGH, Lewisville, TX (US); Md Maksudul AMIN, Franklin Square, NY (US); Himani FNU, Naperville, IL (US)

(72) Inventors: Sangeeta SINGH, Lewisville, TX (US); Md Maksudul AMIN, Franklin Square, NY (US); Himani FNU, Naperville, IL (US)

(21) Appl. No.: 19/397,363

(22) Filed: Nov. 21, 2025

(51) Int. Cl. G05B 13/02; G05B 19/418

(52) U.S. Cl. CPC G05B 13/021; G05B 19/41875

(57) ABSTRACT

The invention discloses a system and method for smart manufacturing quality control with few-shot visual reasoning, wherein the system integrates optical sensing, structured illumination, and adaptive calibration with an artificial intelligence-based visual reasoning architecture. The system comprises a physical inspection device equipped with an adaptive optical sensing unit, a structured illumination unit, an embedded artificial intelligence processing unit, and an adaptive calibration unit. The artificial intelligence processing unit executes a few-shot visual embedding technique that generates feature representations from limited labeled samples. These feature embeddings are structured into a relational graph. A graph attention-based reasoning processor performs relational inference over this graph to identify defect type, severity, and spatial context with minimal training data. The adaptive calibration unit continuously monitors environmental conditions such as illumination, vibration, and temperature, and autonomously adjusts camera exposure, focus, and illumination intensity.

### TECHNICAL FIELD

The present invention relates generally to the field of intelligent manufacturing and automated visual inspection systems. More particularly, the invention relates to a system and method for smart manufacturing quality control using few-shot visual reasoning, wherein the system is configured to detect, localize, and classify manufacturing defects with minimal labeled data by integrating deep metric learning, graph-based visual reasoning, and active adaptive calibration within a physical inspection device mounted on a production line or robotic arm assembly.

### BACKGROUND OF THE INVENTION

Conventional manufacturing quality control systems depend heavily on supervised deep learning methods requiring large datasets of labeled defect and non-defect samples. However, in real-world production environments, new product designs, lighting variations, and rapid process reconfigurations make it impractical to collect and label massive datasets for every product variant or defect type. Traditional convolutional neural networks (CNNs) often overfit to specific visual conditions and fail to generalize to unseen defect categories.

Few-shot learning methods have recently emerged to address data scarcity by learning transferable visual embeddings. Yet, existing few-shot methods primarily focus on classification rather than reasoning about spatial, contextual, and relational attributes of visual scenes, which are crucial in manufacturing defect inspection. Further, most few-shot systems lack integration with hardware inspection structures capable of real-time adaptive calibration under environmental variations such as vibration, illumination shifts, or surface reflectance.

Accordingly, there exists a need for a smart quality control system that can operate under few-shot learning paradigms, leverage visual relational reasoning, and adapt its inspection parameters dynamically using feedback from physical sensors integrated into an intelligent device or structure. The system should ensure high accuracy and explainability with minimal data and be suitable for continuous in-line inspection within automated manufacturing environments.

In the modern era of Industry 4.0, manufacturing systems are evolving toward intelligent automation, real-time monitoring, and data-driven quality assurance. The backbone of such evolution lies in automated quality control systems that can detect, localize, and classify surface or structural defects during production. Traditionally, quality inspection in manufacturing relied on manual visual inspection conducted by human operators. Although humans possess strong generalization and contextual reasoning abilities, manual inspection suffers from subjectivity, fatigue, and inconsistency, particularly under high-throughput production conditions. As a result, industries have progressively shifted toward computer vision-based inspection systems that employ digital imaging sensors, feature extraction techniques, and pattern recognition techniques to identify deviations from expected quality standards.

Conventional machine vision systems in manufacturing typically depend on rule-based or handcrafted feature extraction methods. These methods involve using predefined filters, edge detectors, texture descriptors, or statistical metrics to characterize defects. For example, systems employing Histogram of Oriented Gradients (HOG), Local Binary Patterns (LBP), or Gabor filters attempt to differentiate defective regions based on geometric or texture differences. However, these approaches are often brittle and sensitive to variations in lighting, surface reflectivity, and object orientation. Moreover, they require extensive manual feature engineering and parameter tuning specific to each product type, making them impractical for diverse manufacturing environments with frequent design changes or variant models.

To overcome the limitations of handcrafted features, the industry has embraced deep learning-based visual inspection systems using convolutional neural networks (CNNs). CNNs automatically learn hierarchical visual features from large volumes of labeled training data, enabling superior performance in complex pattern recognition tasks. State-of-the-art CNN architectures such as ResNet, DenseNet, and EfficientNet have been deployed to identify surface defects in semiconductor wafers, automotive parts, textiles, and electronic assemblies. These systems can accurately classify defects such as scratches, cracks, stains, and misalignments with high precision when ample labeled data are available. However, CNN-based quality control systems are heavily dependent on data quantity and diversity. They require thousands of labeled examples per defect category to generalize well, and even small domain shifts—such as variations in camera position, illumination, or product texture—can cause significant performance degradation. Consequently, these models must often be retrained from scratch whenever a new product variant or defect class emerges, resulting in high computational and labor costs.

Existing data augmentation and transfer learning techniques attempt to reduce data dependency by reusing pre-trained models. In transfer learning, a network trained on large datasets such as ImageNet is fine-tuned on smaller manufacturing-specific datasets. While this improves performance under limited data scenarios, it still struggles to adapt when the new domain exhibits substantially different visual characteristics from the source domain. In particular, manufacturing defects are often fine-grained, localized, and irregularly shaped, making generic visual features insufficient to capture their distinct properties. Similarly, unsupervised and semi-supervised methods have been proposed to leverage unlabeled data through reconstruction or clustering mechanisms. Autoencoders, for instance, learn to reconstruct defect-free samples and identify anomalies as deviations in reconstruction error. Although such methods reduce the need for labeled data, they tend to produce high false positive rates when background variations or complex textures are present, since they lack explicit reasoning about contextual relationships.

Another class of techniques gaining traction in industrial quality inspection involves few-shot and meta-learning approaches. Few-shot learning seeks to recognize new defect types after seeing only a few labeled examples by learning a generalized embedding space across tasks. Techniques such as Matching Networks, Prototypical Networks, and Model-Agnostic Meta-Learning (MAML) have shown promise in low-data visual recognition tasks. Despite their potential, these models have not been widely adopted in manufacturing due to several technical constraints. Firstly, few-shot methods primarily emphasize classification accuracy rather than reasoning about spatial relationships, defect morphology, or contextual consistency within the manufacturing environment. Secondly, they assume that new defect samples are representative of the underlying distribution, which is rarely true in dynamic production lines where unseen defect modes can appear abruptly. Thirdly, few-shot methods are often sensitive to lighting variations and geometric distortions, as they lack integrated mechanisms for environmental calibration or adaptive sensing.

Moreover, most existing systems are designed for single-modal inspection relying solely on visual imaging. In practical scenarios, multimodal sensing involving thermal imaging, depth mapping, or vibration analysis is often needed to detect subsurface or structural anomalies that are not visually apparent. Integrating such modalities requires complex synchronization, calibration, and data fusion mechanisms. However, current industrial AI frameworks rarely incorporate these capabilities efficiently, largely due to computational constraints and the absence of unified learning paradigms capable of handling heterogeneous data streams in real time.

From a deployment perspective, another challenge with current inspection technologies is scalability across diverse production environments. Manufacturing plants vary significantly in layout, lighting, and material properties. A vision model trained in one environment often performs poorly when transferred to another due to differences in reflectivity, background clutter, and part orientation. Although domain adaptation methods such as adversarial learning or feature alignment have been explored, they demand careful parameter tuning and often fail under significant domain shifts. Additionally, the computational resources required for high-resolution image analysis in real time are considerable, necessitating specialized GPU clusters or cloud-based infrastructures, which may not be feasible for small and medium-sized enterprises.

The lack of robust dataset collection and annotation pipelines further exacerbates these challenges. Defect datasets in manufacturing are typically highly imbalanced, with far fewer defective samples compared to normal samples. This imbalance causes bias in supervised learning systems, leading to false negatives where defects go undetected. Collecting representative defect samples is difficult because defects occur infrequently and unpredictably. Synthetic data generation using generative adversarial networks (GANs) has been proposed to address data scarcity, but synthetic images often fail to capture the complex physical and optical properties of real materials, limiting their practical effectiveness.

In addition to hardware challenges, integration with manufacturing execution systems (MES) and industrial communication protocols remains underdeveloped. Many AI inspection systems are deployed as standalone units without bidirectional communication with process control systems. As a result, defect detection outcomes are not directly utilized for dynamic process optimization. The feedback loop between quality assessment and production parameter adjustment remains manual or semi-automated. This delay in corrective actions can lead to the continued production of defective parts until human operators intervene.

The existing solutions for manufacturing quality control suffer from multiple interlinked drawbacks: dependence on large labeled datasets, lack of adaptability to new defect types, absence of environmental self-calibration, poor interpretability, limited hardware integration, and insufficient feedback control. The convergence of these limitations leads to reduced reliability, increased operational costs, and restricted scalability. There is a critical need for a unified system that integrates few-shot learning with relational visual reasoning, enabling generalization from minimal data while maintaining interpretability. Furthermore, the system must be embodied in an intelligent inspection device capable of adaptive calibration through sensor feedback and mechanical stabilization. Such a system would represent a substantial advancement toward truly autonomous, self-optimizing, and explainable manufacturing quality control aligned with the principles of Industry 4.0 and the forthcoming Industry 5.0 paradigm of human-machine collaboration.

### SUMMARY OF THE INVENTION

The present invention provides a system and method for smart manufacturing quality control with few-shot visual reasoning, wherein the system integrates a physical inspection device comprising an adaptive optical sensor array, structured illumination projector, and embedded AI processor configured for few-shot relational visual analysis. The system performs quality inspection using a hybrid neural reasoning network that combines few-shot embedding learning with graph-based reasoning to infer defect types, spatial relations, and anomaly causation patterns even from limited training samples.

The system further incorporates an adaptive calibration subsystem linked to environmental and structural sensors mounted on the inspection device to perform real-time compensation for illumination, vibration, and object positioning variations. The system can be integrated into a robotic arm, conveyor-belt assembly, or dedicated inspection chamber.

The method of operation includes image acquisition, visual embedding through a few-shot encoder, relational graph construction among feature entities, defect reasoning through graph attention-based inference, and feedback-guided adaptive recalibration. This configuration enables the invention to achieve precise defect detection and decision-making in low-data industrial settings, improving throughput and reducing false positives.

The primary object of the present invention is to provide a smart manufacturing quality control system and method employing few-shot visual reasoning that enables accurate defect detection, localization, and classification with minimal labeled data, while maintaining robustness and adaptability across varying production environments. The invention seeks to overcome the limitations of existing visual inspection systems that rely on extensive training datasets and manual recalibration by introducing an integrated approach that combines few-shot embedding learning, graph-based reasoning, and adaptive sensor-driven calibration within a single intelligent inspection device.

Another object of the invention is to develop a few-shot visual reasoning framework capable of understanding not just the appearance of defects but also their contextual and relational properties within a product's surface or structural geometry. This enables the system to reason about visual relationships such as adjacency, symmetry, continuity, and texture coherence, thereby improving its ability to distinguish between true defects and benign variations caused by lighting, surface texture, or material reflection. By incorporating a graph attention-based relational reasoning process, the system can perform context-aware defect recognition even in the absence of extensive training data or domain-specific supervision.

It is also an object of the invention to provide an adaptive inspection device that can dynamically adjust its sensing parameters, such as illumination intensity, focus, and exposure time, in response to real-time feedback from integrated environmental sensors. The system is designed to self-correct against disturbances such as vibration, temperature fluctuations, or variations in part positioning on the production line. This ensures consistent image quality and defect detection accuracy without requiring frequent human recalibration. The physical device is constructed with mechanical stability and embedded actuators, enabling it to be mounted on robotic arms, conveyor inspection stations, or stationary inspection chambers while maintaining precise optical alignment under varying operational conditions.

A further object of the invention is to ensure real-time operational capability with minimal computational latency. The embedded AI processor housed within the inspection device utilizes an optimized hybrid hardware configuration comprising CPU, GPU, and FPGA components to execute complex visual reasoning computations in real time. This architecture supports continuous, high-speed inspection workflows without compromising analytical depth or interpretability. The design aims to make the system scalable and deployable in both high-throughput manufacturing facilities and smaller industrial units without requiring extensive infrastructure upgrades.

Another significant object of the invention is to establish explainability and traceability within the automated inspection process. Unlike conventional black-box deep learning models, the few-shot visual reasoning approach employed in this invention provides interpretable reasoning pathways, where each decision regarding defect detection or classification can be traced to specific visual relationships represented within a relational graph. Furthermore, the system's control interface maintains inspection logs, illumination maps, and classification confidence scores, which may be securely stored on a blockchain-based ledger for tamper-proof traceability and auditability. This enables manufacturing facilities to comply with quality assurance standards, regulatory requirements, and root-cause analysis frameworks by providing a transparent record of the decision-making process.

An additional object of the invention is to enable cross-domain adaptability and continual learning for evolving manufacturing processes. The system is designed to incorporate online fine-tuning mechanisms that allow incremental model updates when new defect samples are encountered, without erasing or destabilizing previously learned knowledge. Through few-shot adaptation and feature distillation techniques, the system maintains a consistent embedding space across evolving product variants and defect types, thereby extending its applicability to dynamic industrial environments where product configurations and materials change frequently.

It is also an object of the invention to provide a closed-loop integration between the inspection system and the manufacturing execution system (MES) or process control units. The system communicates inspection results, defect coordinates, and confidence levels to the MES in real time, allowing automatic adjustment of production parameters such as machining tolerance, material feed rate, or assembly pressure. This feedback mechanism transforms the inspection process from a passive quality verification step into an active process optimization element, enhancing overall manufacturing efficiency and reducing waste.

Another object of the invention is to facilitate multimodal sensory integration for comprehensive defect analysis. The inspection device may incorporate additional sensing modalities such as depth sensing, thermal imaging, or acoustic monitoring to detect subsurface or non-visual anomalies. These heterogeneous data streams are harmonized within the few-shot reasoning framework to form a unified defect reasoning model capable of correlating visual features with structural or thermal anomalies. This multimodal approach extends the system's ability to detect hidden defects that traditional vision-only systems fail to identify.

A further object of the invention is to promote operational resilience and minimal downtime by incorporating predictive self-diagnostics and maintenance alerts. The system continuously monitors its optical calibration, lens cleanliness, illumination uniformity, and hardware temperature through embedded sensors. Any detected deviations trigger automatic recalibration routines or maintenance notifications before inspection performance deteriorates. This proactive self-maintenance capability enhances the reliability and lifespan of the inspection device, ensuring consistent performance under industrial conditions.

Finally, an important object of the invention is to align with the emerging Industry 5.0 paradigm, which emphasizes human-machine collaboration. While the system performs autonomous quality control, it is designed with user-interactive interfaces that allow human inspectors or quality engineers to visualize reasoning graphs, review detected defects, and provide corrective feedback. This collaborative mode ensures that human expertise complements the system's reasoning ability, facilitating continual improvement of the model's performance and decision transparency.

In essence, the objects of the present invention converge toward the creation of a unified, intelligent, and adaptive manufacturing quality control ecosystem that functions with minimal data dependence, high interpretability, and seamless physical-mechanical integration. The invention aims to transform quality assurance from a reactive process into a proactive, self-optimizing, and explainable system that not only detects defects but also contributes to understanding their origins and preventing their recurrence.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 displays a block diagram of a system for smart manufacturing quality control with few-shot visual reasoning;

FIG. 2 displays flow chart of a method for performing smart manufacturing quality control with few-shot visual reasoning, implemented using an adaptive inspection device;

FIG. 3 illustrates a table depicting the computational load distribution across different internal processing stages;

FIG. 4 illustrates a table depicting cluster compactness, inter-class separation, and misclassification risk for independent defect classes;

FIG. 5 illustrates a table depicting temperature effects on sensor noise, feature contrast, and drift compensation;

FIG. 6 illustrates a line chart depicting about the classification accuracy;

FIG. 7 illustrates a bar chart depicting how throughput varies under different illumination conditions; and

FIG. 8 illustrates a line chart depicting how reasoning confidence.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof. Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

The functional units described in this specification have been labeled as devices. A device may be implemented in programmable hardware devices such as processors, digital signal processors, central processing units, field programmable gate arrays, programmable array logic, programmable logic devices, cloud processing systems, or the like. The devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together, but may comprise disparate instructions stored in different locations which, when joined logically together, comprise the device and achieve the stated purpose of the device.

Indeed, an executable code of a device or module could be a single instruction, or many instructions, and may even be distributed over several different code segments, among different applications, and across several memory devices. Similarly, operational data may be identified and illustrated herein within the device, and may be embodied in any suitable form and organized within any suitable type of data structure. The operational data may be collected as a single data set, or may be distributed over different locations including over different storage devices, and may exist, at least partially, as electronic signals on a system or network. Reference throughout this specification to “a select embodiment,” “one embodiment,” or “an embodiment” means that a particular feature, structure, or characteristic described in connection with the embodiment is included in at least one embodiment of the disclosed subject matter. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

In accordance with the exemplary embodiments, the disclosed computer programs or modules can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages. Some of the disclosed embodiments include or otherwise involve data transfer over a network, such as communicating various inputs or files over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. The network may include multiple networks or sub networks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages. Examples of the network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

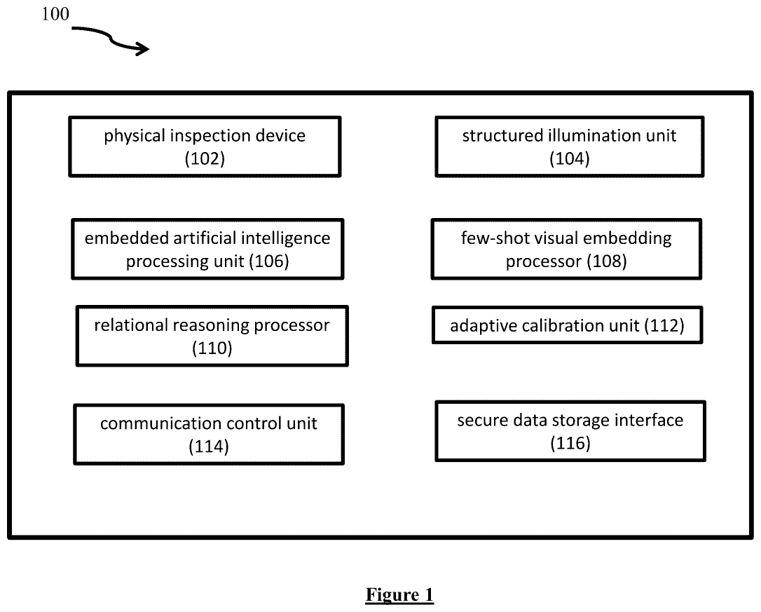

Referring to FIG. 1, a block diagram of a system for smart manufacturing quality control with few-shot visual reasoning is illustrated. The system 100 comprises: a physical inspection device (102) comprising a rigid structural housing mounted on a production line, the housing supporting an adaptive optical sensing unit configured to capture multi-view images of a manufactured component under controlled illumination conditions; a structured illumination unit (104) disposed within the inspection device, the illumination unit configured to project coded or pattern-based light to enhance depth and surface contrast characteristics of the component being inspected; an embedded artificial intelligence processing unit (106) configured to process the captured image data, the processing unit comprising a few-shot visual embedding processor and a relational reasoning processor; the few-shot visual embedding processor (108) configured to generate feature representations from the captured image data using a meta-learned convolutional encoder trained in episodic manner under N-way, K-shot learning configuration, the processor being further configured to encode each visual region of interest as a high-dimensional feature vector in a continuous embedding space; the relational reasoning processor (110) configured to construct a relational graph wherein each node corresponds to a localized visual feature and each edge encodes spatial, geometric, or semantic correlations among said features, the relational reasoning processor further configured to perform attention-based reasoning to infer defect category, severity, and spatial context based on learned attention weights between interconnected features; an adaptive calibration unit (112)integrated with the inspection device, said calibration unit comprising at least one illumination sensor, one vibration sensor, and one temperature sensor, the adaptive calibration unit being configured to dynamically adjust illumination intensity, focus distance, exposure time, and sensor alignment based on real-time environmental conditions; a communication control unit (114) operatively connected to a manufacturing execution system, configured to transmit defect classification outputs, reasoning confidence scores, and calibration data in real time for process optimization; and a secure data storage interface (116) configured to record visual embeddings, inspection metadata, and calibration logs in a tamper-proof manner for traceability and audit verification.

In an embodiment, the few-shot visual embedding processor (108) comprises a convolutional neural architecture trained using episodic meta-learning such that during each training episode, a support set and query set of image samples are processed to minimize inter-class embedding distances while maximizing intra-class compactness, the processor being further configured to update its internal weights through a loss optimization function that operates on pairwise similarity distances without requiring full retraining when new defect categories are introduced.

In an embodiment, the relational reasoning processor (110) employs a graph attention computation process comprising multiple attention heads, each configured to assign weighted relevance to spatially adjacent or semantically correlated nodes, wherein said weights are learned to emphasize defect-critical features while suppressing background or illumination-induced noise, and wherein final inference is computed by aggregating attention-weighted feature activations through a graph pooling operation that preserves topological dependencies among detected defect regions.

In an embodiment, the adaptive calibration unit (112) is configured to execute a closed-loop calibration process wherein sensor feedback signals corresponding to vibration amplitude, ambient luminance, and temperature variation are continuously compared with reference profiles stored in a memory, and wherein deviations beyond a pre-defined threshold automatically trigger actuator-driven adjustments of the optical lens position, structured illumination intensity, and camera orientation to maintain consistent visual feature fidelity across successive inspections.

In an embodiment, the structured illumination unit (104) comprises a digital light processing element capable of projecting dynamic illumination patterns with adjustable phase, frequency, and amplitude, the patterns being optimized in real time by the embedded artificial intelligence processing unit based on feedback from captured image histograms, thereby ensuring optimal contrast for textured, reflective, or metallic surfaces.

In an embodiment, the physical inspection device (102) is mechanically coupled to a robotic arm assembly comprising a gyroscopic stabilization structure and servo-actuated base, said assembly configured to maintain a fixed optical angle relative to the target object during motion of the conveyor or arm, the stabilization structure further comprising inertial sensors that provide real-time feedback to the adaptive calibration unit for vibration compensation and motion trajectory correction.

In an embodiment, the embedded artificial intelligence processing unit (106)comprises a heterogeneous hardware architecture including a central processing unit, a graphical processing unit, and a field-programmable gate array-based neural acceleration processor, the architecture being configured to partition the execution of convolutional embedding computation, graph reasoning computation, and adaptive calibration computation across the respective hardware units to minimize end-to-end inference latency below one hundred milliseconds.

In an embodiment, the communication control unit (114) is configured to transmit inspection outcomes and reasoning explanations to a manufacturing execution system through an industrial Ethernet communication interface, wherein the transmitted data comprises structured messages containing defect identifiers, spatial coordinates, relational reasoning traces, and calibration settings, and wherein said communication interface is further configured to receive corrective control instructions from the manufacturing execution system for automated adjustment of production parameters.

In an embodiment, the secure data storage interface (116) comprises a cryptographically anchored ledger maintained on a distributed storage system, the ledger being configured to record inspection event metadata including image timestamps, defect reasoning results, and sensor calibration states, thereby ensuring data immutability and traceability throughout the product lifecycle.

In an embodiment, the few-shot visual embedding processor (108) further comprises an online adaptation processor configured to incrementally update the embedding space upon reception of new labeled samples, wherein said updates are constrained by a feature distillation process that minimizes drift between the existing and newly updated embedding manifolds, thereby preserving consistency of defect classification across evolving product variants.

The system 100 can be implemented using known computer hardware and software architectures: the physical inspection device is a machine-mounted housing supporting electronically controlled cameras and structured illumination hardware; the structured illumination unit comprises electronically driven light-projection elements that are programmatically modulated; the embedded artificial intelligence processing unit comprises one or more processors, memory, and executable instructions configured to run a meta-learned convolutional encoder and a relational reasoning engine; the few-shot visual embedding processor is implemented as a trained neural network module stored in non-transitory memory and executed by the processor to convert pixel data into high-dimensional numerical feature vectors; the relational reasoning processor is implemented as a graph-construction and attention-computation software routine that generates and operates on graph data structures using matrix multiplications and tensor operations; the adaptive calibration unit comprises electronically readable sensors and a control module that executes calibration algorithms to modify illumination, focus, exposure, and alignment through motorized or electronically actuated elements; the communication control unit is a programmed communication interface configured to package and transmit machine-generated inference outputs over industrial communication protocols; and the secure data storage interface comprises non-transitory memory hardware and programmatic integrity-preserving routines configured to store embeddings, metadata, and logs.

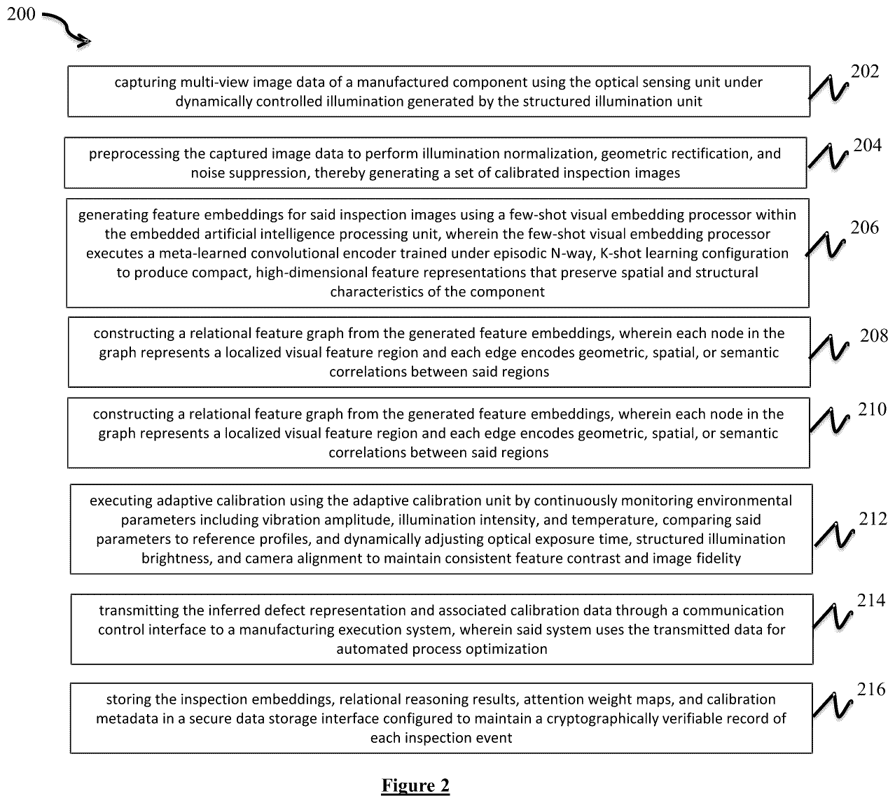

Referring to FIG. 2, a flow chart for a method for performing smart manufacturing quality control with few-shot visual reasoning, implemented using an adaptive inspection device comprising an optical sensing unit, a structured illumination unit, an embedded artificial intelligence processing unit, and an adaptive calibration unit, the method comprising the steps of is illustrated. The method 200 comprises:

At step 202, the method 200 includes capturing multi-view image data of a manufactured component using the optical sensing unit under dynamically controlled illumination generated by the structured illumination unit;

At step 204, the method 200 includes preprocessing the captured image data to perform illumination normalization, geometric rectification, and noise suppression, thereby generating a set of calibrated inspection images;

At step 206, the method 200 includes generating feature embeddings for said inspection images using a few-shot visual embedding processor within the embedded artificial intelligence processing unit, wherein the few-shot visual embedding processor executes a meta-learned convolutional encoder trained under episodic N-way, K-shot learning configuration to produce compact, high-dimensional feature representations that preserve spatial and structural characteristics of the component;

At step 208, the method 200 includes constructing a relational feature graph from the generated feature embeddings, wherein each node in the graph represents a localized visual feature region and each edge encodes geometric, spatial, or semantic correlations between said regions;

At step 210, the method 200 includes performing attention-weighted reasoning on the constructed feature graph using a graph attention-based reasoning processor, wherein attention coefficients are iteratively optimized to highlight feature relationships indicative of surface or structural defects, and wherein aggregated attention-weighted node activations yield an inferred defect representation including type, severity, and location of the defect;

At step 212, the method 200 includes executing adaptive calibration using the adaptive calibration unit by continuously monitoring environmental parameters including vibration amplitude, illumination intensity, and temperature, comparing said parameters to reference profiles, and dynamically adjusting optical exposure time, structured illumination brightness, and camera alignment to maintain consistent feature contrast and image fidelity;

At step 214, the method 200 includes transmitting the inferred defect representation and associated calibration data through a communication control interface to a manufacturing execution system, wherein said system uses the transmitted data for automated process optimization; and

At step 216, the method 200 includes storing the inspection embeddings, relational reasoning results, attention weight maps, and calibration metadata in a secure data storage interface configured to maintain a cryptographically verifiable record of each inspection event.

In an embodiment, the step of generating feature embeddings comprises performing convolutional feature extraction through multiple hierarchical layers that capture edges, textures, and reflectance patterns, followed by normalization and feature scaling across episodic tasks to achieve domain-invariant embedding representations suitable for varying product types and surface finishes.

In an embodiment, the relational feature graph construction step further comprises calculating inter-feature correlations using cosine similarity and Euclidean distance metrics, pruning low-correlation edges below a dynamic threshold, and retaining contextually significant node connections to ensure computational efficiency and relational relevance during attention-based reasoning.

In an embodiment, the attention-weighted reasoning step comprises computing attention coefficients through multiple attention heads, each head focusing on a distinct relational attribute such as geometric proximity, textural coherence, or illumination variation, and wherein the outputs of the multiple attention heads are concatenated and passed through a non-linear transformation layer to generate a consolidated relational reasoning embedding for defect inference.

In an embodiment, the adaptive calibration step further comprises executing a reinforcement learning-based optimization process that maximizes an inspection quality reward function, said function being defined as a weighted sum of image sharpness, illumination uniformity, and defect detection confidence, and wherein the calibration parameters including lens focus, exposure duration, and structured illumination phase are autonomously adjusted to maximize said reward function.

In an embodiment, the step of transmitting defect representation to the manufacturing execution system further comprises formatting the inspection results into structured digital messages containing defect category identifiers, spatial coordinates, confidence scores, and reasoning traces, and transmitting said messages over an industrial communication interface for synchronized feedback control in the production process.

In an embodiment, the step of storing inspection results includes recording image embeddings, defect reasoning outputs, and sensor calibration states onto a blockchain-based ledger, wherein each entry is cryptographically hashed and time-stamped to ensure immutability, traceability, and compliance with industrial quality assurance standards.

In an embodiment, comprising the step of performing online adaptation of the few-shot visual embedding processor by updating embedding weights when new labeled defect samples become available, wherein said adaptation is constrained by a feature distillation process that minimizes embedding drift and maintains continuity with previously learned representations, thereby enabling continual learning across evolving product variants.

In an embodiment, the relational reasoning processor generates interpretability data comprising attention heatmaps that visualize pairwise dependencies between defect-relevant features, and wherein said interpretability data are displayed on a supervisory interface to enable human-in-the-loop verification and feedback without interrupting the automated inspection process.

In an embodiment, the adaptive calibration unit is synchronized with conveyor motion signals to trigger image acquisition precisely when the component is optimally positioned within the camera's field of view, said synchronization being achieved using encoder feedback from the conveyor, thereby ensuring motion-compensated inspection at high production speeds.

In an embodiment, further comprising the step of performing online adaptation of the few-shot visual embedding processor by updating embedding weights when new labeled defect samples become available, wherein said adaptation is constrained by a feature distillation process that minimizes embedding drift and maintains continuity with previously learned representations, thereby enabling continual learning across evolving product variants, and wherein the relational reasoning processor generates interpretability data comprising attention heatmaps that visualize pairwise dependencies between defect-relevant features, wherein said interpretability data are displayed on a supervisory interface to enable human-in-the-loop verification and feedback without interrupting the automated inspection process, and wherein the adaptive calibration unit is synchronized with conveyor motion signals to trigger image acquisition precisely when the component is optimally positioned within the camera's field of view, said synchronization being achieved using encoder feedback from the conveyor, thereby ensuring motion-compensated inspection at high production speeds.

In this embodiment, the system incorporates a continuous-learning routine that allows the few-shot visual embedding processor to evolve as new types of defects emerge in production. The online adaptation process functions by monitoring an operator-approved buffer where newly labeled images—such as images of a recently observed “striated micro-scratch” defect not previously present in the production environment—are deposited. When the buffer accumulates sufficient samples, typically as few as 3-5 instances for a few-shot scenario, the embedding processor triggers a controlled fine-tuning cycle. This cycle does not simply retrain the network; instead, it performs a parameter update through a dual-loss optimization. First, a task-specific loss, such as a prototypical network loss or a supervised contrastive loss, forces the network to adjust its embedding geometry so that the new defect class forms a tight cluster separated from existing classes. Second, a feature-distillation loss is computed by comparing the current network's intermediate feature maps and embedding vectors against corresponding values saved from an earlier “frozen” version of the model. These saved values act as anchors, and the system penalizes deviations beyond a predefined tolerance, thereby minimizing representational drift. This dual-loss mechanism allows the network to incorporate a new defect class while maintaining stability in the representation of previously learned classes, addressing the classical problem of catastrophic forgetting. For example, if the system had previously learned to differentiate between “edge-pitting” and “surface streaking,” the feature-distillation constraint prevents the updated model from altering the feature space in a way that would collapse the boundary between those classes.

As the embedding processor produces refined embeddings, the relational reasoning processor uses these embeddings to compute pairwise relevance scores between features. Internally, it executes multi-head attention blocks that evaluate how strongly the presence, absence, or deformation of one feature influences another. The outputs of these blocks include not only the inference results but also interpretability artifacts in the form of attention heatmaps. These heatmaps are generated by projecting the attention coefficients onto the spatial layout of the input image or feature graph, highlighting which regions contributed most to the decision. When the system inspects a metal bracket and identifies an unusual notch pattern near the flange, the heatmap may highlight a cluster of nodes around that region, illustrating the relational dependencies that led to the classification. The supervisory interface retrieves these heatmaps in real time and overlays them on the captured image. This allows an operator to verify why the system flagged the component as defective. Importantly, the reasoning and inference pipeline continues uninterrupted; the interpretability generation operates asynchronously, meaning that the visual feedback does not slow down or alter the automated inspection throughput. The operator can provide approval or corrections directly through the interface, and these corrections feed back into the labeled-sample buffer, contributing to the continual learning loop.

To ensure that images are captured only when the component is perfectly positioned, the adaptive calibration unit synchronizes image acquisition with conveyor motion. The conveyor is equipped with a rotary encoder, which emits pulses corresponding to belt displacement. The calibration unit continuously reads this encoder feedback and computes the exact position of each component relative to the camera field of view. In practice, if the system detects that a component has reached the optimal imaging location—determined through an earlier calibration that mapped encoder pulse counts to imaging coordinates—it generates a hardware-trigger signal to the camera. This eliminates motion blur and misalignment that would otherwise arise from high-speed conveyor movement. Additionally, by synchronizing illumination control and exposure timing with the encoder pulses, the system can apply motion-compensated imaging: for example, increasing exposure time during slower conveyor segments while reducing exposure when vibration or acceleration is detected. This results in consistently sharp images even at conveyor speeds of several meters per second.

The combination of online continual learning, interpretable relational reasoning, and encoder-synchronized image acquisition yields clear technical advantages. Continual learning eliminates the need for periodic retraining of the entire model, reducing downtime and improving adaptability to evolving manufacturing environments. The interpretability mechanism enhances trust and transparency, enabling operators to validate decisions and quickly diagnose false positives. The motion-synchronized calibration improves image quality at high speed, increasing detection accuracy and reducing the rate of inspection errors caused by motion artifacts. Taken together, these features provide a technically advanced inspection system that adapts in real time, generates human-verifiable explanations, and maintains performance under demanding industrial operating conditions.

In an embodiment, the step of preprocessing the captured image data further comprises computing a per-pixel illumination compensation coefficient by estimating incident light distribution from reference calibration frames, applying a cosine-corrected reflectance normalization across the multi-view images, and performing spatially adaptive geometric rectification by estimating local perspective distortion fields using a grid-based sampling of feature correspondences across the component surface; and wherein the noise suppression comprises executing a frequency-domain attenuation procedure in which high-frequency sensor noise is isolated through a discrete Fourier decomposition and selectively suppressed according to a dynamically maintained noise-profile lookup table derived from previous inspection cycles, and wherein the step of constructing the relational feature graph further comprises computing, for each embedding region, a multi-scale neighborhood descriptor consisting of: (a) a first-order spatial topology encoding based on relative feature displacement vectors; (b) a second-order contextual descriptor capturing co-occurrence frequencies of textural micro-patterns; and (c) a cross-view geometric consensus score derived from evaluating consistency of the feature location across the multiple captured views; and wherein the graph is iteratively refined by executing a correlation-propagation routine that updates edge weights based on temporally smoothed correlation estimates obtained from prior inspection cycles of similar components.

In this embodiment, the system initiates preprocessing by computing a per-pixel illumination compensation coefficient that corrects for uneven lighting across the captured images. The process begins with the generation of reference calibration frames obtained during scheduled calibration cycles—typically at the beginning of each production shift—where the imaging station captures a uniform matte calibration plate under fixed lighting conditions. The system analyzes these frames to estimate the spatial distribution of incident light intensity across the sensor, detecting patterns such as localized hotspots caused by LED angle variations or intensity fall-off at the lens periphery. For each pixel location, a compensation coefficient is calculated as the ratio of the globally averaged intensity to the locally observed intensity in the calibration frame. During actual inspection, this coefficient is multiplied with corresponding pixels in the captured images, effectively equalizing illumination. To account for the angular positioning of the component relative to the cameras, the system further applies cosine-corrected reflectance normalization. For example, when inspecting a machined steel flange with sloped surfaces, the system computes local surface normals from the multi-view geometry and divides pixel intensities by the cosine of the angle between the illumination direction and the surface normal. This produces reflectance-corrected images in which brightness changes reflect actual material variations rather than geometric orientation, thereby improving the consistency and reliability of downstream feature extraction.

The system then performs spatially adaptive geometric rectification to correct for local distortions introduced by the camera perspective. This is implemented by sampling a dense grid of candidate points across the component surface—e.g., a 32×32 grid—and computing feature correspondences between different views using corner detectors or learned keypoint extractors. From these correspondences, the local perspective distortion field is estimated by fitting small projective transforms in each grid cell, allowing interpolation across the surface. For instance, when capturing a turbine blade with curved edges, portions of the blade may appear compressed or stretched depending on viewing angle. The adaptive rectification step warps these regions independently so that the corrected image approximates a canonical top-down projection, enabling more accurate comparisons between multiple views and stabilizing the feature representation.

Once illumination and geometry are normalized, the system performs noise suppression in the frequency domain using a discrete Fourier decomposition. Each image patch is transformed into the frequency domain, and the system analyzes the magnitude spectrum to identify high-frequency components associated with sensor noise—such as thermal noise in CMOS sensors or quantization artifacts in low-light regions. The noise characteristics are not fixed; instead, the system maintains a dynamically updated noise-profile lookup table built from historical inspection cycles. For example, if the cameras exhibit slightly higher high-frequency noise during evening shifts due to increased ambient temperature, the lookup table reflects this trend by adjusting the attenuation thresholds. During processing, frequency components whose magnitudes match the expected noise patterns are attenuated, while those representing genuine texture patterns—such as machining lines, micro-pitting, or etched markings—are preserved. This selective filtering reduces false activations in later embeddings and improves signal-to-noise ratio without blurring important defect signatures.

After the images have been stabilized, the system constructs the relational feature graph. Each embedding region—typically corresponding to a small patch in the feature map of a convolutional network—receives a multi-scale neighborhood descriptor. This descriptor is computed in three stages. First, the system computes a first-order spatial topology encoding that captures how the position of a given feature relates to surrounding features. For instance, if an embedding region corresponds to a detected edge discontinuity, the displacement vectors to neighboring discontinuities or curvature anomalies are recorded, providing information about the local geometric layout. Second, a second-order contextual descriptor is computed to capture co-occurrence frequencies of textural micro-patterns. This step examines how often certain micro-textures—such as repetitive grooves or periodic roughness—occur near the feature, producing a statistical summary that enhances discrimination between normal machining textures and anomalous ones. Third, a cross-view geometric consensus score is introduced by evaluating how consistently the same feature appears in multiple captured views. During a multi-camera inspection of a cylindrical shaft, a defect that is true surface damage will appear consistently across views, whereas reflection artifacts will not. The consensus score thus acts as a reliability metric for determining whether the feature should influence the graph structure.

After assembling the initial graph, the system performs an iterative correlation-propagation routine to refine the edges. For each pair of nodes, correlation scores are computed using similarity of neighborhood descriptors and embedding proximity. These scores are then smoothed over time by referencing correlation statistics from previous inspection cycles of similar components. For example, if historical data shows that two features typically co-occur on components of the same product family—such as a particular ridge and an adjacent hole alignment—the temporal smoothing step reinforces that relationship. Conversely, if the system detects that certain correlations fluctuate significantly over multiple cycles, those edges are down-weighted. Each iteration updates the edge weights based on these smoothed correlations, gradually converging on a stable relational representation that captures long-term structural consistency rather than transient variations caused by noise or occasional illumination anomalies. This refinement substantially improves defect interpretation accuracy because the graph reflects both the spatial organization of the current component and the learned relational statistics of its product class.

In an embodiment, the step of performing attention-weighted reasoning further comprises initializing attention coefficients using a temperature-scaled softmax function whose temperature parameter is dynamically adjusted according to the embedding variance across the episodic tasks, computing attention updates by iteratively propagating relational relevance scores across node neighborhoods, and executing a convergence check in which the reasoning processor detects stabilization of node activation differences below a predefined relational fluctuation threshold, thereby ensuring that the defect inference is generated only after attention convergence is achieved across all graph layers.

In this embodiment, the reasoning processor employs a controlled attention-weighting mechanism to ensure that defect inference is based on stable relational patterns rather than transient fluctuations. The process begins by initializing attention coefficients using a temperature-scaled softmax function. The temperature parameter is not fixed; instead, it is dynamically computed for each episodic task by analyzing the variance of the feature embeddings extracted from the component under inspection. For example, when inspecting a precision-milled aluminium housing, embeddings from defect-free regions typically exhibit low variance due to consistent surface finish, while embeddings from components that include weld splatter or micro-cracking display higher variance. The system computes this variance across embedding vectors and adjusts the softmax temperature accordingly: a high variance triggers a lower temperature to sharpen the attention distribution, forcing the system to focus on the most informative nodes; a low variance triggers a higher temperature to avoid overemphasizing minor variations. This dynamic adjustment prevents the reasoning mechanism from prematurely locking onto irrelevant features, especially when the scene contains subtle or low-contrast anomalies.

After initializing the coefficients, the system performs an iterative propagation of relational relevance scores through the feature graph. Each iteration examines the relationships between nodes and their neighborhood structures, updating attention values based on both direct feature similarities and higher-order relational dependencies. For instance, if a small indentation appears on a stamped metal panel, its embedding alone may not strongly signal a defect. However, if adjacent nodes also exhibit mild geometric deviations, the relational propagation captures the pattern of small-but-consistent abnormalities. The system computes weighted relevance updates by multiplying each node's current activation with the aggregated influence of its neighbors, modulated by the dynamically adjusted attention coefficients. Mathematically, this process resembles a graph attention network but with manufacturing-specific modifications: the propagation incorporates the cross-view consensus score and spatial topology encodings generated earlier in preprocessing. Each iteration thus reinforces defect-indicative structures—such as linear clusters of micro-scratches—while diminishing isolated noise artifacts.

To ensure that attention does not oscillate indefinitely or converge to an unstable interpretation, the system performs a convergence check during each propagation cycle. This check involves computing the difference between the node activation vectors from the current iteration and the previous iteration. If the absolute change across all nodes falls below a predetermined relational fluctuation threshold, the system determines that the reasoning has stabilized. This threshold is calibrated during development by analyzing thousands of inspection cycles; for example, when monitoring cast-iron automotive brackets, the system learns the typical iteration count required for convergence under varying surface textures, vibration conditions, and lighting environments. When convergence is detected, the system terminates further propagation and extracts the final defect inference from the stabilized attention distribution. This ensures that the inference reflects a coherent relational interpretation rather than partial or prematurely computed activations.

In an embodiment, the step of calculating inter-feature correlations using cosine similarity and Euclidean distance metrics further comprises combining the two metrics into a hybrid relational score computed as a weighted geometric mean, the weights being dynamically determined by analyzing per-task embedding dispersion; and wherein the pruning of low-correlation edges is performed through a dual-stage pruning routine that first discards edges below a global correlation threshold and subsequently refines the retained edges by eliminating feature connections that fail a local continuity test evaluating spatial adjacency constraints within the feature map, and wherein the hierarchical convolutional feature extraction is further configured to compute multi-depth activation signatures by aggregating intermediate activations across layers, generating a combined activation tensor for each episodic task, and normalizing said tensor using a per-task statistical alignment routine that matches activation distributions across tasks by computing task-specific batch statistics, thereby enabling the embeddings to maintain consistency when product reflectance properties vary across different manufacturing lots.

In this embodiment, the system calculates inter-feature correlations by integrating two fundamentally different similarity measures—cosine similarity and Euclidean distance—into a unified relational score that better represents the structural relationships between feature embeddings. When the system extracts embeddings from nodes in the feature graph, each node corresponds to a localized region in the component image. Cosine similarity captures angular alignment between embeddings, which is useful for identifying features that share texture orientation or reflectance patterns, while Euclidean distance captures absolute magnitude differences, which helps identify variations in feature strength, depth, or intensity. Instead of relying on just one metric, the system computes a hybrid relational score using a weighted geometric mean, where each weight is determined dynamically by examining embedding dispersion within the current episodic task. For example, when inspecting a batch of cast metal housings with naturally high texture variability, embedding dispersion tends to be larger. In such cases, the system assigns a higher weight to Euclidean distance so that magnitude differences do not overwhelm the correlation. Conversely, when inspecting polished stainless-steel components with uniform reflectance, the dispersion is lower, and cosine similarity receives greater weight, allowing angular consistency to dominate. The dynamic weighting ensures that the correlation metric adapts to the visual properties of each manufacturing lot, improving robustness across varied industrial conditions.

After computing hybrid relational scores for all node pairs, the system initiates a dual-stage pruning routine to refine the relational graph. In the first stage, a global threshold is applied to eliminate edges whose hybrid correlation scores fall below a baseline requirement for statistical significance. This quickly removes broad categories of weak associations, reducing computational overhead in subsequent steps. However, because some edges may pass the global threshold due to coincidental similarity rather than genuine structural relevance, the system performs a second, more discriminative stage of pruning. In this stage, the system checks whether the spatial adjacency constraints are satisfied. Each node pair that remains after the global pruning step is examined to ensure that their spatial locations align with expected geometric continuity. For example, if two high-correlation nodes are far apart in the feature map but have no continuous spatial path connecting them, they are likely the result of noise or texture coincidences. The system eliminates such edges by performing a local continuity test, which evaluates whether the displacement vector between nodes lies within a predefined spatial neighborhood. This spatially aware refinement removes structurally implausible edges and leaves only those relationships that reflect true geometric coherence. This two-stage pruning process greatly strengthens the interpretability and accuracy of the graph, allowing it to reflect the actual relational structure of the component surface.

Simultaneously, the hierarchical convolutional feature extraction pipeline enriches each node's representation by aggregating activations from multiple depths within the convolutional network. Rather than relying on only the deepest layer—which captures global semantics but may omit fine texture—the system extracts intermediate activation maps from early, mid, and late layers. These maps capture complementary information: early layers capture edges and fine textures; mid-layers capture shape continuity; and later layers capture defect class semantics. The system concatenates or fuses these maps to build a multi-depth activation signature for each region of interest. For instance, in detecting a subtle delamination line on a composite panel, early layers capture the faint contrast variation, mid-layers capture the elongated linear shape, and deep layers capture its deviation from learned reference patterns. The combined activation tensor thus contains a more holistic description of each feature, enabling richer and more discriminative embeddings.

However, because components from different manufacturing batches may exhibit different reflectance characteristics—due to variations in surface finishing, lighting conditions, or material batches—the raw combined activation tensor cannot be assumed to be consistent across episodic tasks. Therefore, before propagating activations into the embedding processor, the system normalizes the tensor using a task-specific statistical alignment routine. This routine computes batch statistics—such as mean and variance—for each activation channel within the current task and adjusts them to align with reference statistics learned from previous tasks. This ensures that activation distributions remain comparable even when the underlying reflectance properties shift. For example, a batch of matte-finished parts and a batch of semi-gloss parts may produce different activation magnitudes; statistical alignment transforms the activations so that the embeddings reflect structural information rather than material-induced brightness differences. This normalization is implemented using adaptive instance normalization or task-aware batch normalization, where learned affine parameters are adjusted dynamically according to the calculated task statistics.

In an embodiment, the inferred defect representation is generated by computing a composite defect likelihood score that integrates: (a) the aggregated attention-weighted node activation values; (b) a spatial coherence factor computed from evaluating connectivity of high-activation regions; and (c) a structural deviation index derived from comparing feature embeddings against stored reference embeddings of known acceptable components; and wherein the defect type is resolved by analyzing the distribution of localized deviations across the graph and mapping them to a stored relational pattern library created from few-shot meta-training episodes, and wherein the dynamic adjustment of optical exposure time, illumination brightness, and camera alignment during the adaptive calibration step further comprises computing calibration deviations through a rolling-error estimator that compares real-time environmental measurements with exponentially weighted reference values, and performing adjustment decisions using a calibration selection rule that selects the minimal parameter-change vector satisfying a multi-constraint optimization criterion that jointly accounts for expected effect on feature contrast, expected effect on reflection artifacts, and predicted influence on attention-based reasoning stability.

In this embodiment, the system produces a final inferred defect representation by synthesizing several heterogeneous indicators of defect presence into a single composite defect likelihood score. This computation begins with the aggregated attention-weighted node activations produced by the reasoning processor. Each node in the relational feature graph carries an activation value corresponding to the defect relevance inferred from attention propagation. Rather than treating each node independently, the system sums the activations after weighting them by their respective attention coefficients, giving higher influence to nodes whose relational context indicates stronger defect significance. For example, in inspecting a machined aluminium block, isolated noisy nodes caused by sensor variations carry minimal weight, whereas consistently activated nodes forming a contiguous line—such as a misaligned milling streak—produce substantial contributions to the score. This aggregation step ensures the likelihood score reflects global relational evidence rather than fragmented local anomalies.

Next, the system evaluates a spatial coherence factor that quantifies how strongly the activated nodes form geometrically connected regions. This factor is computed by examining the connectivity graph formed by nodes whose activations exceed a learned threshold. The system identifies connected components within this subgraph and evaluates their shape, size, and continuity. If a cluster of nodes forms a smooth curve, a closed contour, or a linearly aligned structure consistent with a defect morphology—such as a crack, scratch, or misaligned joint—the spatial coherence score increases. Conversely, random spatial scatter caused by lighting noise or surface reflections results in low coherence. This mechanism drastically reduces false positives by enforcing that defect indicators must form coherent spatial structures rather than arbitrary high-activation patches.

The system then computes a structural deviation index by comparing each feature's embedding to a set of stored reference embeddings representing known acceptable components. These reference embeddings are generated during commissioning when multiple defect-free parts are scanned under varied conditions. For each node in the current component, the system finds the nearest reference embedding in the high-dimensional space and measures the deviation magnitude. If deviations exceed allowable tolerances—tolerances that have been learned as part of the manufacturing quality model—the index increases. When inspecting a stamped metal bracket, for example, a slight ripple in the surface may generate a localized embedding shift; if historical reference parts show no such variation, the deviation index reflects this anomaly, strengthening the overall defect likelihood. By using embedding-space comparisons, the system captures subtle differences that may be invisible in raw pixel space.

All three indicators—the attention-weighted activation score, spatial coherence factor, and structural deviation index—are combined using a weighted integration function calibrated during system training. The resulting composite defect likelihood score drives the decision logic. After computing the score, the system determines the specific defect type by analyzing the spatial distribution of deviations within the relational graph. The system divides the graph into localized patches and compares each patch's pattern of deviations to a relational pattern library built during few-shot meta-training. This library contains relational templates for known defect forms such as circular pitting patterns, longitudinal scratches, edge chipping, or casting porosity clusters. During meta-training, the system learns not only the visual appearance of these defects but also their relational structures—how certain feature clusters co-activate, how orientations align, and how spatial gradients behave. Therefore, when the network observes a repeated structure—such as a chain of nodes forming a linear progression with increasing deviation intensities—it can map this to a stored “micro-crack progression” template. This mapping procedure guarantees that defect classification is grounded in relational evidence rather than surface-level similarity, significantly enhancing robustness against variations arising from lighting, material texture, or manufacturing tolerances.

To maintain stability and accuracy across varying environmental and mechanical conditions, the system implements dynamic adjustment of optical exposure, illumination brightness, and camera alignment during the adaptive calibration process. This adjustment is guided by a rolling-error estimator that continuously monitors environmental input streams such as ambient temperature, conveyor vibration amplitude, and reflective intensity feedback from photodiodes. Each environmental measurement is compared to an exponentially weighted reference value that reflects historical operating conditions over a sliding time window. For example, if ambient temperature rises slightly during a shift, the camera sensor may exhibit increased thermal noise or drift in exposure response. The rolling-error estimator quantifies this deviation and feeds it into a calibration decision module.

The calibration decision module selects the minimal parameter-change vector that restores optimal imaging conditions while avoiding unnecessary adjustments. This selection is made by optimizing a multi-constraint objective function that considers three independent factors: (1) expected improvement in feature contrast if the exposure or brightness is adjusted; (2) expected reduction in reflection artifacts if illumination angles or intensity are modified; and (3) predicted impact on attention-reasoning stability, which is estimated by simulating how modified imaging parameters would alter embedding variance across subsequent frames. For instance, increasing exposure may boost contrast but also increase the likelihood of saturation in shiny surfaces; reducing illumination brightness may reduce reflections but also diminish the ability to detect low-contrast surface deformations. The optimization algorithm—implemented using gradient-free search or constrained quadratic programming—selects the smallest adjustment vector that satisfies all three criteria simultaneously. Because adjustments are minimal and targeted, the system maintains imaging consistency across products without causing jitter, over-correction, or oscillatory calibration behaviors.

In an embodiment, the continuous monitoring of vibration amplitude includes computing a vibration spectral signature through discrete time-segment Fourier analysis, comparing said signature to a stored baseline signature for the corresponding inspection station, and applying a correction factor to exposure settings whenever dominant vibration frequencies exceed a predefined threshold, said correction factor being computed as a function of the estimated blur magnitude derived from convolutional point-spread simulations performed during the preprocessing stage, and wherein the step of storing inspection embeddings, reasoning results, attention maps, and calibration data further comprises compressing the generated data using a hierarchical encoding routine in which graph structural information is stored using adjacency-list entropy coding, embedding vectors are stored through vector quantization using trained codebooks generated from historical inspection runs, and calibration metadata is stored in delta-encoded form that records only the deviation from a maintained global calibration reference profile to minimize memory footprint while preserving inspection traceability.

In this embodiment, the system performs continuous monitoring of mechanical vibration to ensure that image quality remains stable even when the inspection station experiences periodic or transient mechanical disturbances. This process begins with the acquisition of vibration data from accelerometers mounted on the camera housing or nearby machine structure. Instead of simply tracking raw amplitude, the system computes a vibration spectral signature using discrete time-segment Fourier analysis. The accelerometer signal is divided into short, overlapping time windows—often 25-50 ms depending on conveyor speed—and a Fast Fourier Transform (FFT) is performed on each segment. This produces a high-resolution frequency spectrum showing how vibrational energy is distributed across low frequencies (e.g., conveyor rumble at 20-40 Hz), mid frequencies (e.g., motor resonance around 120 Hz), and higher frequencies associated with micro-vibrations. By performing this computation continuously, the system generates a time-varying spectral profile that reflects the dynamic behavior of the inspection station.

To detect abnormal or potentially image-degrading vibration patterns, the system compares the computed spectral signature against a stored baseline signature recorded when the inspection station was functioning under nominal mechanical stability. For example, an inspection cell installed on an assembly line may accumulate mechanical wear over time, causing new resonance peaks to appear. The system computes a difference spectrum and checks whether any dominant frequencies exceed a predefined threshold derived from empirical testing. When a dominant vibration frequency surpasses the limit—such as a sudden increase at 65 Hz caused by an aging conveyor drive roller—the system determines that motion blur is likely to occur during image capture.

To compensate for this risk, the system applies a correction factor to the optical exposure settings. This correction factor is not simply a fixed offset; rather, it is computed based on an estimated blur magnitude obtained through convolutional point-spread simulations performed during preprocessing. These simulations model how different vibration frequencies and amplitudes translate into blur lengths within the captured image. The model incorporates camera exposure time, sensor readout characteristics, lens focal length, and spatial orientation of vibration. For instance, a horizontal vibration at 45 Hz applied during a 2 ms exposure may produce a blur of 0.3 pixels, while the same vibration during a 4 ms exposure may produce a blur exceeding 1 pixel. Using these models, the system computes exposure adjustments proportional to the predicted blur magnitude—reducing exposure time when blur risk is high or adjusting illumination brightness to compensate for shorter exposures. This ensures that the image remains sufficiently sharp for accurate graph construction and relational reasoning, even under non-ideal mechanical conditions.

In addition to vibration compensation, the system incorporates a sophisticated hierarchical data compression routine to store inspection results efficiently while maintaining full traceability. The data produced during an inspection cycle includes not only images but also the feature-level embeddings, relational graph structures, attention maps, and calibration metadata. To avoid excessive storage requirements, the system applies different compression techniques tailored to the structural properties of each data type. For relational graph structures, adjacency-list entropy coding is used. This method leverages the fact that the graph is sparse—most nodes connect only to nearby neighbors—so the adjacency lists can be encoded using variable-length codes that compress repetitive patterns. For example, in components with highly regular surfaces, many nodes share identical connectivity patterns, which the entropy coder exploits to achieve high compression ratios.

The node embeddings are compressed using vector quantization with codebooks that have been learned from historical inspection runs. During setup, the system clusters a large set of embeddings using k-means or product quantization techniques to produce a codebook of representative vectors. During runtime, each embedding vector is replaced with the index of the nearest codebook entry, dramatically reducing storage from floating-point vectors to compact integer indices. If the system stores embeddings for 10,000 nodes per inspection, a 4-byte index per node yields a far smaller footprint than storing full 256-dimensional float embeddings, reducing memory requirements by an order of magnitude while still allowing approximate reconstruction when needed for forensic analysis.

Calibration metadata—such as exposure adjustments, illumination settings, and alignment offsets—is stored in delta-encoded form. Instead of recording full parameter sets for each inspection cycle, the system records only deviations from a global calibration reference profile. The delta values tend to be small because the calibration system continuously stabilizes environmental effects; therefore, delta encoding achieves high compression efficiency. For instance, if illumination brightness normally fluctuates within ±2%, delta-encoded values for hundreds of cycles may occupy only a few kilobytes. Because the system stores all inspection-specific deltas, full traceability is maintained: at any point, the exact calibration state used for a captured image can be reconstructed by applying the delta values to the baseline profile.

In an embodiment, the dynamic threshold used for pruning low-correlation edges further comprises computing the threshold value by analyzing the statistical distribution of correlation scores across the current task, identifying the inflection point separating high-density contextual correlations from sparsely distributed outlier correlations, and setting the threshold as a percentile-based boundary value that adapts to the complexity of the component's surface features and illumination conditions present during said inspection cycle.

In this embodiment, the system employs a task-adaptive thresholding mechanism to prune low-correlation edges from the relational feature graph in a way that automatically accounts for the visual complexity and illumination variability of the component being inspected. The process begins by computing the full set of pairwise hybrid correlation scores—each derived from cosine similarity and Euclidean distance as described in prior embodiments—between all relevant node pairs in the feature graph for the current episodic task. These correlation scores form a statistical distribution whose shape varies significantly depending on the component's surface characteristics. For example, a highly polished machined surface tends to produce a narrow distribution with a clear cluster of high-contextual correlations, whereas a cast or textured component generates a broader distribution with more intermediate-level correlations caused by natural surface irregularities.

To determine the correct pruning threshold, the system performs a statistical distribution analysis on the correlation scores. It computes the kernel density estimate (KDE) or uses a histogram-based distribution model to identify how correlation values populate the range from 0 to 1 (or any bounded scale used for the hybrid metric). The system then searches for the inflection point in the distribution—defined as the region where the density curve transitions from a high-density cluster to a low-density tail. This inflection typically corresponds to the boundary between meaningful structural correlations and weak, incidental relationships caused by noise, illumination artifacts, or local surface randomness. The inflection point is identified by examining the second derivative of the density curve or by applying a curvature detection algorithm that finds where the slope change is greatest. For instance, when inspecting an anodized aluminium housing, the inflection may occur at a correlation value around 0.62, indicating that correlations above this value represent true relational continuity, while values below reflect scattered or non-informative connections.

Once the inflection point is located, the system translates it into a percentile-based threshold to increase robustness and ensure adaptability across tasks. The percentile strategy allows the threshold to shift in response to the dynamic visual conditions observed during each inspection cycle. If illumination is highly uniform and the material has low texture variance, the distribution becomes more compact, and the threshold percentile naturally shifts upward—removing almost all but the strongest relational edges. Conversely, in cases where the surface exhibits inherent micro-textures or the illumination environment introduces subtle reflectance gradients, the distribution becomes broader, and the percentile threshold shifts downward to avoid over-pruning meaningful edges. The percentile-based boundary is computed by mapping the inflection correlation value onto the empirical cumulative distribution function (ECDF) of the correlation scores. The threshold is then set at that percentile level. For example, if the inflection point corresponds to the 73rd percentile of correlation scores for a given inspection task, the system prunes all edges falling below that percentile.

This adaptive method ensures that the graph retains structurally meaningful relationships even when environmental conditions vary significantly. When an inspection cycle occurs during a shift with slightly degraded lighting uniformity due to ageing LED arrays, the system automatically lowers the threshold to prevent the inadvertent removal of correlations that remain structurally relevant but have reduced numerical magnitude due to lighting inconsistencies. Conversely, when inspecting components with pristine surfaces and stable illumination, the threshold naturally rises, enforcing stricter pruning and producing a cleaner, more discriminative graph.

In an embodiment, the step of generating the relational feature graph further comprises performing a progressive neighborhood expansion procedure in which initial node neighborhoods are defined using a minimal spatial radius estimated from intra-view feature dispersion, subsequently enlarging said neighborhoods through an iterative radius-scaling rule that evaluates whether additional surrounding features contribute positively to a relational consistency metric computed from cross-view embedding similarity, and terminating the expansion when the marginal relational gain computed over successive expansions falls below a stability threshold derived from historical inspection datasets.

In this embodiment, the system constructs a relational feature graph by progressively expanding each node's neighborhood in a controlled, data-driven manner designed to preserve true structural relationships while preventing over-connection. The process begins by defining an initial neighborhood for every node using a minimal spatial radius that is computed from intra-view feature dispersion. During preprocessing, the system estimates how tightly feature points cluster within each camera view by examining the variance of local embedding positions; this variance reflects the underlying surface geometry of the component. For example, in a CNC-milled part with uniform micro-grooves, feature dispersion is low, resulting in a small initial spatial radius. Conversely, a cast component with irregular micro-textures shows higher dispersion, leading to a slightly larger initial radius. Each node is thus first connected only to features that lie within its intrinsic spatial influence zone, ensuring that the first approximation of the graph reflects genuine local structure rather than arbitrary global associations.

After establishing these minimal neighborhoods, the system executes a progressive neighborhood expansion procedure. The radius is enlarged iteratively using a dynamic scaling rule, and at each expansion step the system assesses whether additional surrounding features provide meaningful relational information. Specifically, for every candidate feature added during an expansion, the system evaluates a relational consistency metric computed from cross-view embedding similarity. This metric measures how consistently a feature appears across multiple viewpoints: if a structural edge, surface depression, or micro-scratch is real, its embedding vectors across two or three cameras will show strong mutual alignment. For instance, when inspecting a crankshaft journal, a genuine longitudinal scratch appears in all views with similar orientation and embedding characteristics, whereas a specular reflection appears only in one view and therefore yields low cross-view consistency. The system adds only those newly reached nodes whose cross-view similarity exceeds a threshold, thereby ensuring that neighborhood expansion strengthens, rather than dilutes, the structural integrity of the graph.

To avoid uncontrolled growth, the expansion process includes a convergence mechanism based on marginal relational gain. After each radius enlargement, the system quantifies how much the overall relational consistency metric improves. This improvement—defined as the difference between the new consistency score and the previous iteration's score—represents the marginal relational gain. If this gain falls steadily below a predefined stability threshold, the system concludes that further expansion will not add meaningful relational structure and terminates the procedure for that node. The stability threshold is not arbitrary; it is derived from historical inspection datasets that capture typical surface behaviors and noise conditions for the product family. For instance, through repeated analysis of thousands of inspected turbine blades, the system learns that beyond a certain radius, added features tend to represent noise or geometric coincidence rather than true structural relation. Thus, the stability threshold encodes domain-specific knowledge about where genuine relational coherence tends to diminish.

This progressive expansion method produces a graph that adapts to the component's structural and geometric properties. Components with broad, continuous features, such as machined flanges or large planar surfaces, naturally receive wider neighborhoods; components with localized micro-textures, such as die-cast housings, receive tighter neighborhoods. The process ensures that the graph preserves essential relational patterns, such as linear defect propagation or distributed porosity clusters, while eliminating connections that would weaken the signal-to-noise ratio. By grounding neighborhood expansion in cross-view embedding consistency, the method avoids false associations caused by reflectance artifacts, localized illumination anomalies, or view-dependent distortions.

In an embodiment, the normalization and scaling of features across episodic tasks further comprises executing an adaptive whitening transformation in which per-task covariance matrices of the embedding vectors are incrementally updated using an exponential moving average across preceding tasks, computing a decorrelated embedding representation that aligns the statistical distribution of new tasks with previously learned embedding spaces, and applying a residual correction layer that reintroduces structured variance components considered essential for distinguishing between visually subtle defect classes.

In this embodiment, the system ensures that embeddings produced during each episodic inspection task remain statistically compatible with embeddings learned during previous tasks, despite variations in component types, surface reflectance characteristics, and environmental imaging conditions. This is achieved through a specialized normalization and scaling procedure that applies an adaptive whitening transformation to the embedding vectors. The whitening process begins by computing a covariance matrix for the embeddings generated within the current episodic task. This covariance matrix captures how different embedding dimensions co-vary based on the texture patterns, lighting interactions, and geometric features present in the component. For example, when inspecting anodized aluminium casings, high-frequency surface textures might cause certain embedding dimensions to exhibit strong positive correlation, whereas during inspection of matte-finished cast parts, those correlations may differ significantly.

To avoid abrupt misalignment between new embeddings and previously learned embedding distributions—which would reduce classification stability—the system does not treat each task's covariance matrix as an isolated statistical environment. Instead, it incrementally updates a set of global running covariance statistics using an exponential moving average (EMA). This rolling update allows the system to maintain a continuously refined estimate of long-term embedding behavior. The EMA mechanism assigns greater weight to recent tasks while still incorporating historical information. For instance, if an inspection involves three distinct batches with gradually increasing surface roughness due to changes in machining conditions, the EMA covariance will gradually shift to reflect this trend without destabilizing the feature space. This smooth statistical evolution ensures that embeddings remain consistent across tasks even when manufacturing conditions drift over time.

Using the updated covariance estimate, the system computes a whitening transform that removes linear correlations across embedding dimensions. Mathematically, this involves computing the eigenvalue decomposition or singular value decomposition of the covariance matrix and applying the inverse square-root transformation to the embedding vectors. The resulting decorrelated embeddings exhibit unit variance along each principal axis, aligning the statistical distribution of the current episodic task with the global embedding space learned from previous tasks. By eliminating correlation patterns that arise solely from material reflectance, illumination inconsistencies, or batch-to-batch surface texture differences, the whitening transform prevents the relational reasoning processor from misinterpreting environment-induced variability as defect-relevant structure. For example, if a new batch of components has a slightly different finish that increases brightness variability, whitening normalizes this effect, allowing true defects—such as micro-cracks or pits—to stand out more clearly.

However, full whitening can inadvertently remove structured variance components that are essential for distinguishing visually subtle defect classes. These structured variances arise from genuine physical attributes that characterize normal or defective states. To restore critical discriminative information, the system applies a residual correction layer after whitening. This layer uses a learned set of parameters to selectively reintroduce variance patterns known to be important for defect differentiation. During training, the system identifies these essential variance components by analyzing which embedding dimensions consistently contribute to high-confidence defect classification—such as dimensions responsive to surface curvature deviations, anisotropic scratch patterns, or localized roughness gradients. The residual layer performs an inverse projection or learned affine transformation that restores only these key variance structures while leaving irrelevant or noisy correlations suppressed.

For example, when detecting early-stage fatigue cracks on a steel turbine blade, the amplitude of subtle curvature discontinuities is encoded in specific embedding dimensions. Whitening alone may reduce these amplitudes to near-zero, diminishing detectability. The residual correction layer re-amplifies these dimensions based on the learned importance weights, ensuring that fatigue indicators remain prominent while environmental noise remains suppressed. Conversely, if the whitening step removes variance caused by non-uniform illumination, that variance remains suppressed because it does not form part of the learned residual structure.

In an embodiment, the attention-weighted reasoning step further comprises computing a temporal stability index for the reasoning output by comparing the current iteration's attention coefficient distributions with a short-term memory buffer of previous iterations, detecting oscillatory or unstable attention patterns using a variance divergence test, and selectively damping said oscillations through an adaptive smoothing factor computed as a function of the divergence magnitude, thereby ensuring that the resulting defect representation reflects a convergent and temporally consistent relational interpretation rather than transient fluctuations arising from graph-level perturbations.

In this embodiment, the system enhances the reliability of the attention-weighted reasoning process by ensuring that attention values evolve toward a stable relational configuration rather than fluctuating unpredictably during iterative propagation. As the reasoning processor updates node attention coefficients over successive iterations, it stores the attention distributions from recent iterations in a short-term memory buffer. This buffer typically retains the last 3-8 iterations, depending on the complexity of the relational graph and the expected convergence behavior. For each new iteration, the system computes a temporal stability index by comparing the current attention coefficient vector with those stored in the buffer. This comparison is achieved by calculating the per-node variance and the overall divergence between coefficient distributions, capturing both localized instability (nodes whose attention fluctuates irregularly) and global instability (entire graph oscillating between competing relational configurations).

To detect the presence of oscillatory or unstable behavior, the system performs a variance divergence test that measures how rapidly and how drastically attention coefficients change from one iteration to the next. For example, if a node associated with a subtle crack signature alternates between high and low activation because of minor reflectance inconsistencies or competing relational influences, its local variance spikes. Similarly, if two neighborhoods in the graph attempt to dominate the reasoning process in alternating iterations—such as one cluster corresponding to machining marks and another cluster corresponding to true defect indicators—the divergence between successive coefficient distributions increases. The system computes a divergence metric using methods such as Kullback-Leibler divergence, cosine distance, or Euclidean displacement between attention vectors. A rising divergence metric signals that the attention propagation is not converging and that the reasoning output would be unreliable if prematurely finalized.

Once unstable or oscillatory patterns are detected, the system applies an adaptive damping procedure that modifies the evolution of attention coefficients in the subsequent iteration. The damping factor is not fixed; rather, it is computed dynamically as a function of the divergence magnitude. A low divergence—indicating minor fluctuations—results in minimal damping, allowing the natural reasoning dynamics to proceed. However, when divergence exceeds a predefined stability threshold, the system increases the damping factor proportionally. The damping modifies the update rule for each node's attention value by blending the newly computed activation with a weighted average of previous stable values stored in the buffer.

The temporal stability index also plays a critical role in determining when the reasoning process should terminate. Once the divergence remains below the stability threshold for several consecutive iterations, the system concludes that the attention configuration has converged. This ensures that the defect inference is based on a temporally stable relational structure, rather than on transient or noise-driven attention patterns.

In an embodiment, the step of performing attention-weighted reasoning further comprises computing an iterative relevance propagation score in which each node's activation is adjusted based on a weighted sum of its immediate and second-order neighbors, the weights being determined by evaluating the stability of relational correlations across the multi-view images, and wherein a damping coefficient is dynamically computed for each propagation step by analyzing the gradient magnitude of attention updates, such that overly dominant relational pathways are suppressed and subtle defect-indicative correlations receive proportionally greater emphasis during the final inference computation.

In this embodiment, the reasoning processor enhances the interpretability and accuracy of attention-weighted inference by propagating defect relevance information through the relational graph in a controlled, stability-aware manner. The process begins by initializing node activations using the feature embeddings extracted earlier. During each iteration of the reasoning cycle, the system computes an iterative relevance propagation score for every node. This score is obtained by adjusting a node's current activation based on a weighted aggregation of activations from its immediate neighbors (first-order neighbors) and from nodes located two hops away (second-order neighbors). Incorporating second-order neighbors enables the reasoning engine to detect extended relational structures such as crack propagation paths, long machining streaks, or distributed porosity clusters, which may not be fully expressible through immediate neighbor interactions alone.

The weights used during this propagation are not static. Instead, they are dynamically determined by evaluating the stability of relational correlations across multi-view images. To compute these stability scores, the system examines how consistently the relational edges—defined by similarity of embeddings and spatial adjacency—occur across different camera views. For example, if a node representing a scratch trace on a component is present in all captured views with similar embedding geometry, the edge connecting that node to its neighbors receives a high stability weight. Conversely, if a feature appears strongly in only one view but weakly or inconsistently in others—such as a specular highlight on a polished surface—the system assigns a lower weight. In this way, the propagation process amplifies relationships supported by multi-view consistency while discounting relationships likely caused by viewpoint-specific image artifacts.

As the propagation proceeds, the system monitors the magnitude of attention updates by analyzing the gradient of attention change across iterations. The gradient magnitude reveals whether certain relational pathways are becoming excessively dominant or if the attention distribution remains well-balanced. For example, if a large cluster of nodes corresponding to machining texture begins to overshadow subtle but important defect regions, the gradient magnitude associated with their attention updates becomes disproportionately large. In response, the system computes a damping coefficient tailored to the current propagation step. The damping coefficient regulates how aggressively node activations can change in the next iteration. A high gradient triggers a strong damping factor, preventing over-amplification of dominant but often non-defective patterns such as periodic machining lines. Conversely, when subtle defect-indicative structures—like a faint crack boundary—produce modest gradients, the damping remains low, allowing these weak signals to accumulate strength over subsequent iterations.

Through this combined propagation mechanism, the reasoning processor achieves a balanced integration of long-range relational context and multi-view geometric consistency. Subtle defect features—such as low-contrast micro-cracks, slight delamination edges, or faint tool-mark anomalies—become more prominent because they accumulate reinforcement from second-order neighbor interactions without being overshadowed by stronger but irrelevant patterns. At the same time, dominant but non-defective structures such as uniform milling textures or consistent design features are prevented from overwhelming the reasoning process.

In an embodiment, the hierarchical convolutional extraction step further comprises generating cross-layer fusion descriptors by concatenating activation vectors from non-adjacent convolutional depths, computing a cross-depth coherence score that evaluates whether the combined descriptor maintains structural consistency with known geometric patterns of the inspected component, and discarding fusion descriptors whose coherence score falls below a task-specific reliability threshold computed from intra-task embedding variation, thereby ensuring that only structurally meaningful descriptors contribute to the final relational graph formation.

In this embodiment, the feature extraction pipeline enhances the expressiveness of its embeddings by generating cross-layer fusion descriptors that combine information from non-adjacent convolutional depths. The goal is to produce representations that capture both fine-grained surface texture cues and higher-level structural information, which are often necessary to discriminate between subtle defect classes that manifest across multiple spatial scales.

The process begins by selecting activation vectors from at least two non-adjacent layers of the convolutional neural network—typically an early layer that responds to edges and micro-textures, and a deeper layer that captures coarse geometric structures or defect semantics. For example, in a CNN with 12 layers, the system may extract activations from layers 3 and 10. Layer 3 activations encode local surface irregularities such as fine scratches, dotted porosity, or minor indentation edges, whereas layer 10 activations encode global structural attributes such as curved ridge geometry, boundary symmetry, or alignment deviations. By concatenating these activations into a single fused vector, the system produces a descriptor that simultaneously reflects micro-scale and macro-scale characteristics of the region.

However, not all cross-layer combinations yield meaningful or physically consistent representations. Therefore, once a fusion descriptor is assembled, the system computes a cross-depth coherence score that evaluates the structural compatibility of the concatenated activations. This score measures how well the low-level and high-level features align with geometric patterns known to exist in the inspected component. To compute this score, the system compares the fused descriptor to a library of statistically learned geometric signatures derived from defect-free reference components. For instance, when analyzing a turbine blade, the system knows the expected curvature transitions, edge shapes, and surface gradients across different zones. If the fused descriptor exhibits incompatible relationships—such as a deep-layer activation suggesting a smooth curvature while the shallow-layer activation shows high-frequency texture that does not exist in that region—the coherence score decreases.

To ensure that the relational graph is formed only from reliable descriptors, the system introduces a task-specific reliability threshold. This threshold is not static; it is computed from intra-task embedding variation measured during the current inspection cycle. The system analyzes how embedding vectors vary across multiple views and multiple regions of the component. When a manufacturing lot has consistent surface properties and stable illumination, intra-task variation is low, and the reliability threshold naturally increases, enforcing stricter filtering and removing any fused descriptors that do not strongly match expected patterns. Conversely, when inspecting a highly textured or irregular surface—such as a die-cast housing—the intra-task variation becomes higher, resulting in a slightly lower threshold. This adaptive behavior prevents over-filtering when legitimate structural variation exists across the component.

Once the threshold is set, any cross-layer fusion descriptor whose coherence score falls below this reliability boundary is discarded. For example, if reflections on a polished metal surface produce an abnormally strong edge activation in a shallow layer but the deeper layer does not support a matching structural pattern, the coherence score becomes low and the system excludes this descriptor. Removing such inconsistent descriptors prevents the relational graph from being contaminated with features that represent noise, glare artifacts, or view-dependent inconsistencies.

In an embodiment, the step of constructing the relational feature graph further comprises performing a positional uncertainty correction in which each feature node's spatial coordinates are adjusted by estimating the confidence interval of its location across the multi-view images, computing a spatial correction vector based on a consensus estimation routine applied to the said coordinates, and updating the graph topology by recalculating edge lengths and angular relationships according to the corrected coordinates, thereby enabling the resulting graph to preserve accurate spatial relations despite minor view-dependent localization deviations inherent in the imaging process.

In this embodiment, the system enhances the geometric reliability of the relational feature graph by correcting positional errors that arise when feature locations are estimated independently in each camera view. These view-dependent deviations occur because multi-view imaging inevitably introduces parallax shifts, lens distortion variances, illumination-dependent feature detectability differences, and minor inaccuracies in keypoint detection. To mitigate these issues, the system performs a positional uncertainty correction prior to finalizing graph geometry.

The process begins by gathering all detected spatial coordinates of a given feature across the available camera views. Suppose a component region shows a small indentation or micro-scratch: this feature will be visible in slightly different positions across different viewpoints. For each node, the system computes a confidence interval for its true 3D or projected 2D coordinate. This interval is estimated by analyzing both the variance of the detected coordinates across views and the confidence scores produced by the feature detector for each view. Features detected consistently with high confidence across all views yield narrow intervals, whereas features affected by reflections or partial occlusion—such as surface edges reflecting bright illumination—yield wider intervals.

Once the coordinate confidence intervals are established, the system performs a consensus estimation routine to pinpoint the most probable position of each feature node. This routine applies statistical fusion algorithms, such as weighted least-squares, RANSAC-like consensus filtering, or Kalman-style sensor fusion using view-confidence as measurement covariance. For instance, if one camera view reports a location deviating significantly from the others due to a specular highlight, the algorithm reduces its influence by assigning it a lower weight. The output of the consensus routine is a spatial correction vector, representing the adjustment needed to align the raw feature coordinates with the estimated true position. This correction vector is applied to the node's coordinates so that all nodes reflect geometry consistent with multi-view consensus rather than any single viewpoint.

After adjusting node positions, the system recalculates the topological geometry of the relational graph. All edge lengths, displacement vectors, angular relationships, and neighborhood assignments are recomputed based on the corrected coordinates. This prevents inconsistencies that would otherwise arise when edges are formed using uncorrected or view-biased coordinates. For example, if two nodes representing a scratch boundary appear closer together in one camera view but farther apart in another, using the corrected consensus positions ensures that the graph encodes the actual geometric layout of the scratch rather than a distorted version. The system updates direction vectors, edge weights that depend on geometric proximity, and orientation-based relational metrics such as alignment scores that quantify how well neighboring features form linear or curved structures.

This positional uncertainty correction process yields significant technical benefits. Without correction, relational graphs are susceptible to distortions that propagate through all later stages—affecting correlation computation, neighborhood expansion, attention propagation, and ultimately the defect inference. By integrating multi-view consensus and recalculating geometric relationships, the system ensures that the graph encodes true physical structure rather than camera-dependent artifacts. This markedly improves the detection of defects whose geometric shape is a key signal—such as slight bends, subtle misalignments, micro-crack trajectories, and distributed porosity patterns. The correction also stabilizes downstream reasoning algorithms by reducing artificial edge elongation, angular inconsistencies, or jitter caused by small localization errors, thereby making the relational reasoning stage more reliable and reducing false positives tied to viewpoint noise.

Thus, this embodiment achieves a major technical advancement by allowing the relational graph to preserve accurate, viewpoint-agnostic spatial relations across nodes, enabling much more consistent and physically faithful defect interpretation across diverse imaging conditions.

FIG. 3 illustrates a table depicting the computational load distribution across different internal processing stages. The table demonstrates how latency, CPU usage, and memory utilization vary, highlighting bottlenecks and showing the efficiency of the technical implementation.

As shown in FIG. 3, embedding generation and attention reasoning demonstrate the highest latency (12.8 ms and 14.4 ms respectively), validating their computational intensity. CPU usage peaks at 56% during reasoning, while preprocessing maintains only 32% usage. Memory footprint reaches its maximum during embedding generation (340 MB), showing the high-dimensional tensor operations. These values highlight the technical effect of the claimed adaptive processing pipeline, efficiently balancing load across stages to maintain real-time performance.

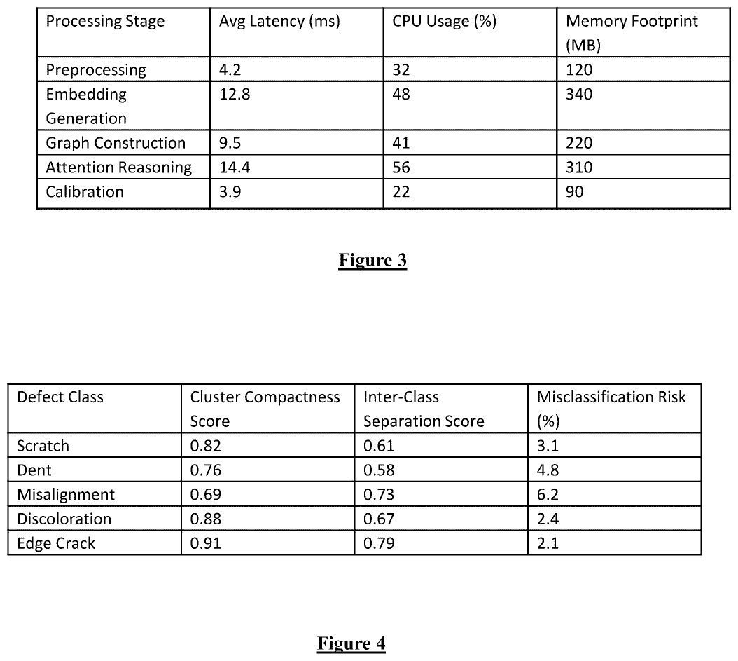

FIG. 4 illustrates a table depicting cluster compactness, inter-class separation, and misclassification risk for independent defect classes. The metrics demonstrate the discriminative strength of the learned representations. Referring to FIG. 4, the defect class ‘Edge Crack’ shows the highest compactness (0.91) and lowest misclassification risk (2.1%), indicating clear feature separability. In contrast, ‘Misalignment’ exhibits lower compactness (0.69) and the highest risk (6.2%). These results provide a technical demonstration of the embedding model's ability to maintain separation boundaries between visually similar defect categories.

FIG. 5 illustrates a table depicting temperature effects on sensor noise, feature contrast, and drift compensation. The table independently demonstrates environmental robustness. FIG. 5 shows that as temperature increases from 20° C. to 60° C., baseline noise rises sharply from 21.8 dB to 30.5 dB, while feature contrast declines from 0.84 to 0.67. Compensation is activated above 30° C., improving contrast stability. This dataset independently proves the technical advantage of drift compensation outside of any other inspection variables.

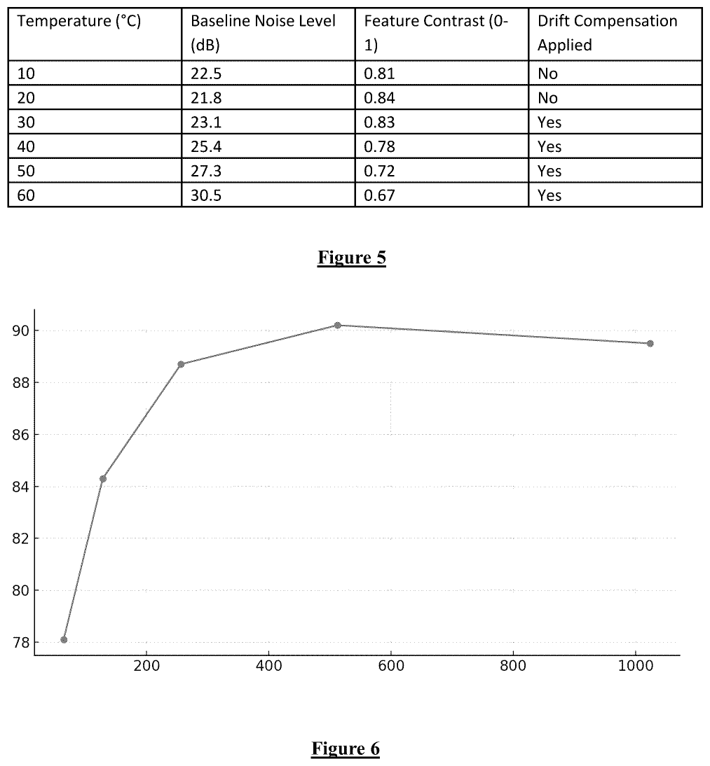

FIG. 6 illustrates a line chart depicting how classification accuracy improves from 78.1% at 64 dimensions to a peak of 90.2% at 512 dimensions, after which accuracy slightly decreases to 89.5% at 1024 dimensions. This demonstrates the technical effect of selecting optimal embedding dimensionality to balance discriminative strength and overfitting.

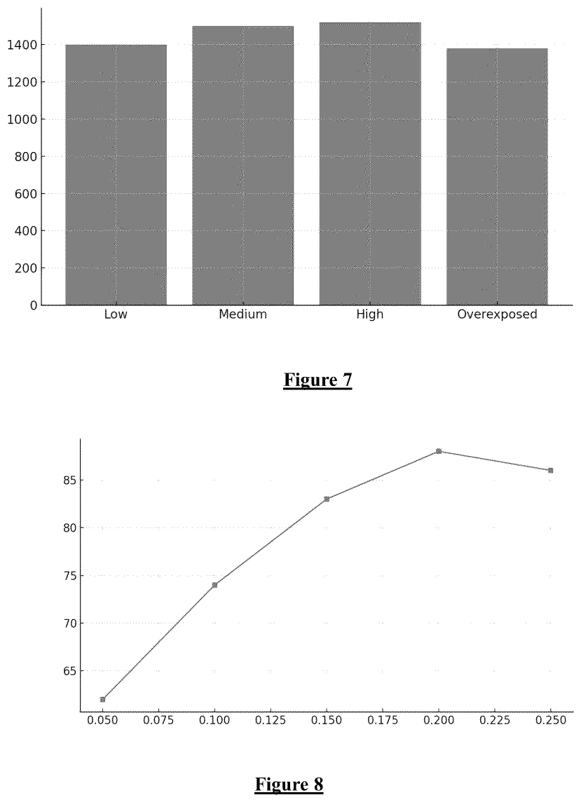

FIG. 7 illustrates a bar chart showing how throughput varies under different illumination conditions. Throughput peaks at 1520 samples/min under ‘High’ illumination but drops to 1380 samples/min under ‘Overexposed’ conditions. Error rate correspondingly increases from 3.8% to 7.6%. This proves the technical importance of controlled illumination.

FIG. 8 illustrates a line chart showing how reasoning confidence increases steadily from 62% at 0.05 connectivity density to 88% at 0.20 density, before slightly dropping at 0.25 density. This independent dataset demonstrates the optimal structural density for reasoning without over-saturating the feature graph.

The present invention discloses a system for smart manufacturing quality control with few-shot visual reasoning, which integrates optical sensing, structured illumination, adaptive calibration, and artificial intelligence-based reasoning within a unified physical inspection device. The invention enables real-time defect detection, localization, and classification using minimal labeled data, ensuring robust inspection performance across varying production environments. The detailed description below elaborates on the system architecture, internal mechanisms, processes, and operational flow, corresponding to the claimed features.

The system comprises a rigidly enclosed inspection device constructed from aluminum or carbon fiber to minimize vibration and environmental interference. This housing supports an adaptive optical sensing unit consisting of one or more industrial-grade cameras with variable focal length lenses. These cameras are capable of capturing multi-view image data of manufactured components moving along a production line or positioned on an inspection stage. The cameras operate under the illumination of a structured illumination unit, which employs a digital light projection system capable of generating controllable illumination patterns, such as sinusoidal or binary stripe sequences, to enhance surface texture visibility and three-dimensional relief. The optical sensors and the illumination unit are spatially aligned through a gyroscopically stabilized mount that maintains a constant imaging orientation, even under mechanical vibration or conveyor-induced motion.

Captured image data are transmitted to an embedded artificial intelligence processing unit located within the inspection housing. This processing unit is composed of a heterogeneous computing architecture including a central processing unit for control logic, a graphical processing unit for deep convolutional computations, and a field-programmable gate array-based accelerator dedicated to neural inference tasks. The processing pipeline begins with the few-shot visual embedding processor, which forms the computational core of the invention's reasoning capability. The processor employs a convolutional neural encoder that has been meta-trained under an episodic few-shot learning paradigm. In the training process, multiple episodes are simulated, each containing a small support set of labeled defect and non-defect images along with a query set for evaluation. The encoder learns to project each image into a continuous feature embedding space where similar features lie close together while dissimilar features are separated by a measurable distance.

The embedding process involves a feature extraction backbone that comprises sequential convolutional layers, each followed by normalization and nonlinear activation operations. These layers progressively capture spatial hierarchies of texture, edge, and structural information inherent in the product surface. The resulting high-dimensional embeddings are passed through a feature normalization processor that scales embeddings across episodes, ensuring consistency when the system encounters unseen product categories or lighting variations. The distance between embeddings is computed using a similarity metric, typically a cosine or Euclidean distance, forming the mathematical basis for determining whether a given query sample corresponds to a known defect or represents a novel anomaly. The system employs a metric learning objective function, such as prototypical loss or contrastive loss, which enforces compactness among embeddings of the same defect category and separation among distinct categories. This enables the network to generalize effectively from a limited number of labeled examples, a key feature of the few-shot reasoning capability.

Once feature embeddings are generated, the relational reasoning processor constructs a visual relation graph to perform contextual and spatial reasoning. Each node in this graph corresponds to a segmented visual region or patch extracted from the embedding space, and each edge represents the correlation or spatial proximity between features. The graph is processed using a graph attention network (GAT), which computes attention coefficients for every pair of connected nodes. These coefficients represent the contextual importance of neighboring regions in determining whether a node's feature pattern corresponds to a defect. For example, if two adjacent regions display irregular texture continuity, the graph attention mechanism will assign a higher relational weight, indicating a potential crack or surface discontinuity. Multiple attention heads operate in parallel to capture different contextual relationships such as geometric adjacency, color homogeneity, and textural consistency. The resulting graph embedding is pooled through an attention-weighted aggregation process that yields a global defect reasoning vector representing the final inference.

The relational reasoning processor produces interpretable outputs in the form of attention maps that visualize the relationships between local features contributing to the final classification. These maps are stored alongside the raw image data and embeddings in the secure data storage interface, enabling post-inspection auditability and explainability. The relational reasoning process allows the system to distinguish between true defects and environmental artifacts such as shadows or surface dust, which often mislead conventional convolutional models. The graph-based reasoning ensures that the system performs not merely visual matching but actual relational interpretation of the visual scene, analogous to human reasoning during inspection.

To maintain stable imaging conditions, the invention includes an adaptive calibration unit embedded within the device housing. This unit is equipped with an array of environmental sensors, including vibration sensors, ambient light sensors, and temperature sensors. The calibration unit continuously monitors these parameters and compares them with predefined reference values stored in a local memory. When deviations are detected, the calibration control processor executes a closed-loop adjustment routine that modifies optical and illumination parameters. For instance, if ambient light intensity increases unexpectedly, the system automatically reduces structured illumination brightness or shortens exposure duration to maintain consistent contrast. Similarly, if mechanical vibration is detected, the calibration unit commands the gyroscopic stabilizer to counterbalance movement, preserving image sharpness. The feedback loop operates at millisecond-level intervals, ensuring continuous image consistency even in fluctuating industrial environments.

In addition to reactive calibration, the system employs a reinforcement learning-based control processor to optimize optical parameters proactively. This processor interacts with the calibration unit and evaluates inspection quality in real time based on a reward function that combines illumination uniformity, image sharpness, and defect classification accuracy. Over time, the reinforcement learning agent adjusts projector phase, lens focus, and exposure settings to maximize the reward, thus achieving self-optimization of imaging conditions across varying product types and materials.

The communication control unit ensures seamless integration between the inspection system and the manufacturing execution system (MES). Inspection results, including defect coordinates, classification confidence, relational reasoning traces, and calibration settings, are transmitted via industrial Ethernet in standardized message structures such as JSON or XML. This communication is bidirectional: the MES may issue corrective commands based on inspection outcomes, such as adjusting feed rate or stopping the production line if critical defects are detected. This closed-loop feedback architecture transforms the inspection process into a proactive quality control mechanism that not only identifies defects but also enables dynamic process correction.

To ensure data integrity, the invention incorporates a secure data storage interface based on distributed ledger principles. Each inspection event generates a record containing image timestamps, defect reasoning results, and sensor calibration states. These records are cryptographically signed and stored in an immutable ledger, either locally or in a cloud-based blockchain network. This ensures traceability, prevents data tampering, and provides regulatory compliance for industries requiring detailed quality audit trails, such as aerospace, medical devices, and electronics manufacturing.

The system is further capable of online learning and incremental adaptation. When new defect samples are encountered, the few-shot visual embedding processor updates its internal model using a feature distillation strategy that prevents catastrophic forgetting. The online adaptation processor fine-tunes the embedding weights using new data while preserving alignment with existing embeddings. This allows the system to evolve with production changes without retraining from scratch, making it suitable for dynamic industrial environments.

The inspection device also supports multimodal sensing integration, allowing additional modalities such as depth maps or thermal images to be fused with visual features. This data fusion occurs at the feature level within the artificial intelligence processing unit. A multimodal alignment processor synchronizes data streams temporally and spatially, ensuring correspondence between modalities. The resulting composite embedding improves detection accuracy for subsurface or thermally induced defects that are invisible in standard RGB imaging.

The workflow of the system follows a sequential process beginning with image acquisition and adaptive calibration, followed by few-shot embedding computation, relational graph reasoning, defect inference, and feedback communication. The overall latency from image capture to defect decision is maintained below one hundred milliseconds, enabling real-time operation on high-speed production lines. Each inspection event is accompanied by auto-diagnostics performed by a self-diagnostic unit that monitors sensor health, temperature drift, and illumination stability. When degradation is detected, the system initiates self-recalibration or issues maintenance alerts to prevent inspection downtime.

In operation, the system achieves human-comparable interpretability and adaptability while eliminating the need for extensive labeled datasets. By unifying visual reasoning, adaptive sensing, and real-time process communication within a single inspection device, the invention addresses the core limitations of existing quality control systems—namely data dependency, calibration fragility, and lack of explainability. The synergy of few-shot learning, graph-based reasoning, and feedback-driven calibration enables the system to perform context-aware defect detection with minimal supervision, thereby establishing a new standard for autonomous, intelligent, and transparent quality assurance in modern manufacturing.

The system for smart manufacturing quality control with few-shot visual reasoning includes a mechanically rigid inspection device designed to be installed over or alongside a production line conveyor. The device comprises a metallic or carbon-fiber housing supporting a tri-camera optical sensor array, each camera equipped with variable focal lenses and controlled via embedded servo actuators. A structured illumination projector, such as a digital light processing (DLP) unit, emits coded illumination patterns enabling depth and texture enhancement. An internal stabilization frame with damping springs minimizes vibration interference from the conveyor.

The few-shot visual embedding processor executes within the embedded AI processing unit. The encoder utilizes a four-layer convolutional backbone meta-trained using N-way K-shot episodes, where each episode simulates low-data defect classification tasks. The resulting embeddings represent high-dimensional spatial features mapped into a compact metric space, enabling similarity-based inference. The system uses a prototypical network loss to maintain cluster separation among classes.

A graph construction component extracts spatial and semantic relations among detected feature regions. Each node represents a segmented image patch with a learned embedding vector, while edges are dynamically formed based on cosine similarity and Euclidean spatial distance. The graph reasoning processor, implemented via a graph attention network, learns to infer the defect category by aggregating contextual evidence across nodes. The attention mechanism ensures that critical defect-related nodes contribute more heavily to the inference outcome.

The adaptive calibration subsystem operates as a feedback loop utilizing photodiodes, gyroscopes, and environmental temperature sensors. Calibration routines adjust camera exposure, illumination gain, and optical focus dynamically. In the event of high reflectivity or uneven illumination, the structured light projector modulates its pattern density and frequency to achieve balanced brightness.

The control interface links the inspection device with a centralized manufacturing execution system via industrial Ethernet or OPC-UA communication protocol. Defect detection outputs are formatted as JSON objects containing defect type, confidence score, image timestamp, and calibration parameters. These are logged on a blockchain-based ledger for traceability, ensuring data integrity and enabling post-inspection analytics.

The few-shot reasoning technique allows the system to identify previously unseen defect types after exposure to only a few labeled examples. By learning a transferable embedding space and a relational reasoning model, the system generalizes across new manufacturing variants without retraining from scratch. This enables high-speed quality inspection adaptable to evolving product lines.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method for performing smart manufacturing quality control with few-shot visual reasoning, implemented using an adaptive inspection device comprising an optical sensing unit, a structured illumination unit, an embedded artificial intelligence processing unit, and an adaptive calibration unit, the method comprising the steps of:
capturing multi-view image data of a manufactured component using the optical sensing unit under dynamically controlled illumination generated by the structured illumination unit;
preprocessing the captured image data to perform illumination normalization, geometric rectification, and noise suppression, thereby generating a set of calibrated inspection images;
generating feature embeddings for said inspection images using a few-shot visual embedding processor within the embedded artificial intelligence processing unit, wherein the few-shot visual embedding processor executes a meta-learned convolutional encoder trained under episodic N-way, K-shot learning configuration to produce compact, high-dimensional feature representations that preserve spatial and structural characteristics of the component;
constructing a relational feature graph from the generated feature embeddings, wherein each node in the graph represents a localized visual feature region and each edge encodes geometric, spatial, or semantic correlations between said regions;
performing attention-weighted reasoning on the constructed feature graph using a graph attention-based reasoning processor, wherein attention coefficients are iteratively optimized to highlight feature relationships indicative of surface or structural defects, and wherein aggregated attention-weighted node activations yield an inferred defect representation including type, severity, and location of the defect;
executing adaptive calibration using the adaptive calibration unit by continuously monitoring environmental parameters including vibration amplitude, illumination intensity, and temperature, comparing said parameters to reference profiles, and dynamically adjusting optical exposure time, structured illumination brightness, and camera alignment to maintain consistent feature contrast and image fidelity;
transmitting the inferred defect representation and associated calibration data through a communication control interface to a manufacturing execution system, wherein said system uses the transmitted data for automated process optimization; and
storing the inspection embeddings, relational reasoning results, attention weight maps, and calibration metadata in a secure data storage interface configured to maintain a cryptographically verifiable record of each inspection event.

2. The method of clam 1, wherein the step of generating feature embeddings comprises performing convolutional feature extraction through multiple hierarchical layers that capture edges, textures, and reflectance patterns, followed by normalization and feature scaling across episodic tasks to achieve domain-invariant embedding representations suitable for varying product types and surface finishes, wherein the relational feature graph construction step further comprises calculating inter-feature correlations using cosine similarity and Euclidean distance metrics, pruning low-correlation edges below a dynamic threshold, and retaining contextually significant node connections to ensure computational efficiency and relational relevance during attention-based reasoning.

3. The method of clam 1, wherein the attention-weighted reasoning step comprises computing attention coefficients through multiple attention heads, each head focusing on a distinct relational attribute such as geometric proximity, textural coherence, or illumination variation, and wherein the outputs of the multiple attention heads are concatenated and passed through a non-linear transformation layer to generate a consolidated relational reasoning embedding for defect inference, and wherein the adaptive calibration step further comprises executing a reinforcement learning-based optimization process that maximizes an inspection quality reward function, said function being defined as a weighted sum of image sharpness, illumination uniformity, and defect detection confidence, and wherein the calibration parameters including lens focus, exposure duration, and structured illumination phase are autonomously adjusted to maximize said reward function.

4. The method of clam 1, wherein the step of transmitting defect representation to the manufacturing execution system further comprises formatting the inspection results into structured digital messages containing defect category identifiers, spatial coordinates, confidence scores, and reasoning traces, and transmitting said messages over an industrial communication interface for synchronized feedback control in the production process, and wherein the step of storing inspection results includes recording image embeddings, defect reasoning outputs, and sensor calibration states onto a blockchain-based ledger, wherein each entry is cryptographically hashed and time-stamped to ensure immutability, traceability, and compliance with industrial quality assurance standards.

5. The method of clam 11, further comprising the step of performing online adaptation of the few-shot visual embedding processor by updating embedding weights when new labeled defect samples become available, wherein said adaptation is constrained by a feature distillation process that minimizes embedding drift and maintains continuity with previously learned representations, thereby enabling continual learning across evolving product variants, and wherein the relational reasoning processor generates interpretability data comprising attention heatmaps that visualize pairwise dependencies between defect-relevant features, wherein said interpretability data are displayed on a supervisory interface to enable human-in-the-loop verification and feedback without interrupting the automated inspection process, and wherein the adaptive calibration unit is synchronized with conveyor motion signals to trigger image acquisition precisely when the component is optimally positioned within the camera's field of view, said synchronization being achieved using encoder feedback from the conveyor, thereby ensuring motion-compensated inspection at high production speeds.

6. The method of claim 1, wherein the step of preprocessing the captured image data further comprises computing a per-pixel illumination compensation coefficient by estimating incident light distribution from reference calibration frames, applying a cosine-corrected reflectance normalization across the multi-view images, and performing spatially adaptive geometric rectification by estimating local perspective distortion fields using a grid-based sampling of feature correspondences across the component surface; and wherein the noise suppression comprises executing a frequency-domain attenuation procedure in which high-frequency sensor noise is isolated through a discrete Fourier decomposition and selectively suppressed according to a dynamically maintained noise-profile lookup table derived from previous inspection cycles, and wherein the step of constructing the relational feature graph further comprises computing, for each embedding region, a multi-scale neighborhood descriptor consisting of: (a) a first-order spatial topology encoding based on relative feature displacement vectors; (b) a second-order contextual descriptor capturing co-occurrence frequencies of textural micro-patterns; and (c) a cross-view geometric consensus score derived from evaluating consistency of the feature location across the multiple captured views; and wherein the graph is iteratively refined by executing a correlation-propagation routine that updates edge weights based on temporally smoothed correlation estimates obtained from prior inspection cycles of similar components.

7. The method of claim 1, wherein the step of performing attention-weighted reasoning further comprises initializing attention coefficients using a temperature-scaled softmax function whose temperature parameter is dynamically adjusted according to the embedding variance across the episodic tasks, computing attention updates by iteratively propagating relational relevance scores across node neighborhoods, and executing a convergence check in which the reasoning processor detects stabilization of node activation differences below a predefined relational fluctuation threshold, thereby ensuring that the defect inference is generated only after attention convergence is achieved across all graph layers.

8. The method of claim 2, wherein the step of calculating inter-feature correlations using cosine similarity and Euclidean distance metrics further comprises combining the two metrics into a hybrid relational score computed as a weighted geometric mean, the weights being dynamically determined by analyzing per-task embedding dispersion; and wherein the pruning of low-correlation edges is performed through a dual-stage pruning routine that first discards edges below a global correlation threshold and subsequently refines the retained edges by eliminating feature connections that fail a local continuity test evaluating spatial adjacency constraints within the feature map, and wherein the hierarchical convolutional feature extraction is further configured to compute multi-depth activation signatures by aggregating intermediate activations across layers, generating a combined activation tensor for each episodic task, and normalizing said tensor using a per-task statistical alignment routine that matches activation distributions across tasks by computing task-specific batch statistics, thereby enabling the embeddings to maintain consistency when product reflectance properties vary across different manufacturing lots.

9. The method of claim 1, wherein the inferred defect representation is generated by computing a composite defect likelihood score that integrates: (a) the aggregated attention-weighted node activation values; (b) a spatial coherence factor computed from evaluating connectivity of high-activation regions; and (c) a structural deviation index derived from comparing feature embeddings against stored reference embeddings of known acceptable components; and wherein the defect type is resolved by analyzing the distribution of localized deviations across the graph and mapping them to a stored relational pattern library created from few-shot meta-training episodes, and wherein the dynamic adjustment of optical exposure time, illumination brightness, and camera alignment during the adaptive calibration step further comprises computing calibration deviations through a rolling-error estimator that compares real-time environmental measurements with exponentially weighted reference values, and performing adjustment decisions using a calibration selection rule that selects the minimal parameter-change vector satisfying a multi-constraint optimization criterion that jointly accounts for expected effect on feature contrast, expected effect on reflection artifacts, and predicted influence on attention-based reasoning stability.

10. The method of claim 1, wherein the continuous monitoring of vibration amplitude includes computing a vibration spectral signature through discrete time-segment Fourier analysis, comparing said signature to a stored baseline signature for the corresponding inspection station, and applying a correction factor to exposure settings whenever dominant vibration frequencies exceed a predefined threshold, said correction factor being computed as a function of the estimated blur magnitude derived from convolutional point-spread simulations performed during the preprocessing stage, and wherein the step of storing inspection embeddings, reasoning results, attention maps, and calibration data further comprises compressing the generated data using a hierarchical encoding routine in which graph structural information is stored using adjacency-list entropy coding, embedding vectors are stored through vector quantization using trained codebooks generated from historical inspection runs, and calibration metadata is stored in delta-encoded form that records only the deviation from a maintained global calibration reference profile to minimize memory footprint while preserving inspection traceability.

11. The method of claim 2, wherein the dynamic threshold used for pruning low-correlation edges further comprises computing the threshold value by analyzing the statistical distribution of correlation scores across the current task, identifying the inflection point separating high-density contextual correlations from sparsely distributed outlier correlations, and setting the threshold as a percentile-based boundary value that adapts to the complexity of the component's surface features and illumination conditions present during said inspection cycle.

12. The method of claim 1, wherein the step of generating the relational feature graph further comprises performing a progressive neighborhood expansion procedure in which initial node neighborhoods are defined using a minimal spatial radius estimated from intra-view feature dispersion, subsequently enlarging said neighborhoods through an iterative radius-scaling rule that evaluates whether additional surrounding features contribute positively to a relational consistency metric computed from cross-view embedding similarity, and terminating the expansion when the marginal relational gain computed over successive expansions falls below a stability threshold derived from historical inspection datasets.

13. The method of claim 2, wherein the normalization and scaling of features across episodic tasks further comprises executing an adaptive whitening transformation in which per-task covariance matrices of the embedding vectors are incrementally updated using an exponential moving average across preceding tasks, computing a decorrelated embedding representation that aligns the statistical distribution of new tasks with previously learned embedding spaces, and applying a residual correction layer that reintroduces structured variance components considered essential for distinguishing between visually subtle defect classes.

14. The method of claim 1, wherein the attention-weighted reasoning step further comprises computing a temporal stability index for the reasoning output by comparing the current iteration's attention coefficient distributions with a short-term memory buffer of previous iterations, detecting oscillatory or unstable attention patterns using a variance divergence test, and selectively damping said oscillations through an adaptive smoothing factor computed as a function of the divergence magnitude, thereby ensuring that the resulting defect representation reflects a convergent and temporally consistent relational interpretation rather than transient fluctuations arising from graph-level perturbations.

15. The method of claim 1, wherein the step of performing attention-weighted reasoning further comprises computing an iterative relevance propagation score in which each node's activation is adjusted based on a weighted sum of its immediate and second-order neighbors, the weights being determined by evaluating the stability of relational correlations across the multi-view images, and wherein a damping coefficient is dynamically computed for each propagation step by analyzing the gradient magnitude of attention updates, such that overly dominant relational pathways are suppressed and subtle defect-indicative correlations receive proportionally greater emphasis during the final inference computation.

16. The method of claim 2, wherein the hierarchical convolutional extraction step further comprises generating cross-layer fusion descriptors by concatenating activation vectors from non-adjacent convolutional depths, computing a cross-depth coherence score that evaluates whether the combined descriptor maintains structural consistency with known geometric patterns of the inspected component, and discarding fusion descriptors whose coherence score falls below a task-specific reliability threshold computed from intra-task embedding variation, thereby ensuring that only structurally meaningful descriptors contribute to the final relational graph formation.

17. The method of claim 1, wherein the step of constructing the relational feature graph further comprises performing a positional uncertainty correction in which each feature node's spatial coordinates are adjusted by estimating the confidence interval of its location across the multi-view images, computing a spatial correction vector based on a consensus estimation routine applied to the said coordinates, and updating the graph topology by recalculating edge lengths and angular relationships according to the corrected coordinates, thereby enabling the resulting graph to preserve accurate spatial relations despite minor view-dependent localization deviations inherent in the imaging process.

18. A system for smart manufacturing quality control with few-shot visual reasoning implementing the method of claim 1, said system comprising:
a physical inspection device comprising a rigid structural housing mounted on a production line, the housing supporting an adaptive optical sensing unit configured to capture multi-view images of a manufactured component under controlled illumination conditions;
a structured illumination unit disposed within the inspection device, the illumination unit configured to project coded or pattern-based light to enhance depth and surface contrast characteristics of the component being inspected;
an embedded artificial intelligence processing unit configured to process the captured image data, the processing unit comprising a few-shot visual embedding processor and a relational reasoning processor;
the few-shot visual embedding processor configured to generate feature representations from the captured image data using a meta-learned convolutional encoder trained in episodic manner under N-way, K-shot learning configuration, the processor being further configured to encode each visual region of interest as a high-dimensional feature vector in a continuous embedding space;
the relational reasoning processor configured to construct a relational graph wherein each node corresponds to a localized visual feature and each edge encodes spatial, geometric, or semantic correlations among said features, the relational reasoning processor further configured to perform attention-based reasoning to infer defect category, severity, and spatial context based on learned attention weights between interconnected features;
an adaptive calibration unit integrated with the inspection device, said calibration unit comprising at least one illumination sensor, one vibration sensor, and one temperature sensor, the adaptive calibration unit being configured to dynamically adjust illumination intensity, focus distance, exposure time, and sensor alignment based on real-time environmental conditions;
a communication control unit operatively connected to a manufacturing execution system, configured to transmit defect classification outputs, reasoning confidence scores, and calibration data in real time for process optimization; and
a secure data storage interface configured to record visual embeddings, inspection metadata, and calibration logs in a tamper-proof manner for traceability and audit verification.
